(19) United States
(12) Patent Application Publication
(10) Pub. No.: US 2003/0079330 A1
(43) Pub. Date: May 1, 2003

(54) Apparatus and method for applying discrete components onto a moving web

(76) Inventors: James Bennington Stopher, Pocatello, ID (US); Carl William Olson, Larsen, WI (US); Patrick Sean McNichols, Hortonville, WI (US); Gregory Arthur Krummel, Appleton, WI (US); Robert Eugene Vogt, Neenah, WI (US); Alain-Rene Bourassa, St-Thomas d'Aquin (CA)

Correspondence Address: KIMBERLY-CLARK WORLDWIDE, INC., 401 NORTH LAKE STREET, NEENAH, WI, 54956

(21) Appl. No.: 10/003,911

(22) Filed: Nov. 1, 2001

(51) Int. Cl. B23P 11/00

(52) U.S. Cl. 29/430

(57) ABSTRACT

A method and apparatus (20) for changing the speed of discrete components (22) can include a first rotatable drive member (32), and at least a second rotatable drive member (42) which is substantially coaxial with the first drive member (32). A first servo motor (34) is connected to rotate the first drive member (32), and at least a second servo motor (34) is connected to rotate the second drive member (42). A first transfer puck (36) is driven by the first rotatable drive member (32), and at least a second transfer puck (46) is driven by the second rotatable drive member (42). A first electronic drive (38) is connected to the first servo motor (34), and is configured to selectively move the first transfer puck (36) at a first, pick up speed (V1) and at least a second, deposit speed (V2). At least a second electronic drive (48) is connected to the second servo motor (44), and is configured to selectively move the second transfer puck (46) at the first pick up speed and at the second deposit speed (V2).

### FIELD OF THE INVENTION

The present invention relates to an apparatus and method for receiving discrete components or components traveling at a selected speed and changing the speed to move the components at a different speed. The apparatus and method which can receive discrete components or components traveling at a selected speed and can accelerate or decelerate the components to move at a different speed. The invention can more particularly concern an apparatus and method can receive discrete, component sections of a moving web of source material which is traveling at a selected speed, and can apply the discrete component sections onto a product web which is traveling at a different speed.

### BACKGROUND OF THE INVENTION

Articles, such as disposable diapers, generally have been manufactured by a process where discrete components or components of different materials, such as leg elastic, waist elastic, tapes, and other fasteners such as hook and loop materials or snaps, have been applied to a continuously moving product web. The product web can represent an interconnected plurality of individual articles. Often, the speed at which the components are fed into the process differs from the speed of the product web itself. To properly apply the components onto the product web without adversely affecting the process or the finished articles, the speed of the components must be changed to match the speed of the product web.

Several different conventional methods for changing the speed of a component or component of material such that it can be applied to a continuously moving web have been known to those skilled in the art. For example, one method has been referred to as the slip gap or slip cut method. A web of material, which is traveling at a slower speed than the moving web, is fed into a knife and anvil roll having a surface speed equal to the speed of the moving web. As the material is cut into discrete components, vacuum in the anvil roll is activated to draw the components of material to the surface of the anvil roll. The anvil roll then carries the components to the moving web where the vacuum is released and the components are applied to the moving web while both the components and the moving web are traveling at the same speed.

Another method has utilized festoons to reduce the speed of the moving web to match the speed of the discrete components of material to be applied to the web. The moving web is temporarily slowed down to the speed of the components with the excess portion of the moving web gathering in festoons. The components of material are then applied to the moving web while both the components and the web are traveling at the same speed. The festoons are then released allowing the moving web to return to its original speed.

A device for severing a web traveling at a first speed into discrete components and then applying the components onto a product web traveling at a second speed has included a plurality of transfer pucks which are configured to rotate about a common first axis. The device has employed a drive ring which has been configured to rotate about a second axis which is offset from the first axis of the transfer pucks. A plurality of coupler arms are pivotally connected to the drive ring. As the drive ring is rotated, a cam end of each of the coupler arms is guided along a curvilinear path and a crank end of each of the coupler arms slideably engages a respective transfer puck thereby pivoting the coupler arms about the pivot points and rotating the transfer pucks at a variable speed. The offset crank motion of the drive ring and the pivoting of the coupler arms independently varies an effective drive radius of each transfer puck to provide the desired variable speed.

Another device for receiving discrete components travelling at a first speed and applying the components to a substrate web travelling at a second speed has included at least one rotatable transferring mechanism, a driving mechanism and at least one driven mechanism. The rotatable transferring mechanism has been connected to an output shaft and moves along an orbital path through a receiving zone where the components are received and an application zone where the components are applied to the substrate web.

The driving mechanism has utilized at least one rotatable noncircular drive gear connected to an input shaft to transmit rotational energy to the driven mechanism. The driven mechanism has utilized at least one rotatable noncircular driven gear connected to the output shaft or to a jackshaft to accept the rotational energy from the driving mechanism and transmit the energy to the transferring mechanism. The input shaft and the output shaft (or jackshaft) have been offset such that the noncircular drive gear is configured to engage and rotate the noncircular driven gear which, in turn, rotates the rotatable transferring mechanism.

Conventional methods, such as those described above, have exhibited several drawbacks. Where the surface speed of the mechanism used to transfer the components is greater than the initial speed of the components, the components are often subjected to a tugging action. The tugging action may result in an undesirable elongation or tearing of the components. Second, several of the conventional methods have provided substantial speed variations but have not provided sufficient durations of time where the speed remains sufficiently constant. As a result, the discrete components may be adversely affected because the surface speed of the transfer mechanism has been excessively changing during the receiving and application operations. Additionally, the conventional devices have had expensive and complicated mechanics, and excessive amounts of time have been required for adjusting the device to accommodate different operating speeds and components of different size. As a result, there has been a continuing need for a variable speed method and apparatus which can more accurately and more efficiently provide the different speeds over selected dwell periods, dwell lengths or other dwell intervals.

### BRIEF DESCRIPTION OF THE INVENTION

The present invention can provide an apparatus and method for changing the speed of discrete components. The apparatus can include a first rotatable drive member, and at least a second rotatable drive member which is substantially coaxial with the first drive member. A first servo motor can be connected to rotate the first drive member, and at least a second servo motor can be connected to rotate the second drive member. A first transfer puck is driven by the first rotatable drive member, and at least a second transfer puck is driven by the second rotatable drive member. A first electronic drive can be connected to the first servo motor, and can be configured to selectively move the first transfer puck at a first, pick up speed and at least a second, deposit speed. At least a second electronic drive can be connected to the second servo motor, and can be configured to selectively move the second transfer puck at the first pick up speed and at the second deposit speed.

In a process aspect, a method for changing the speed of discrete components onto a moving substrate can include a rotating of a first rotatable drive member with a first servo motor, and a rotating of at least a second rotatable drive member with a second servo motor. The second rotatable drive member is substantially coaxial with the first drive member. A first transfer puck can be moved with the first rotatable drive member, and the first transfer puck can be configured to place a first discrete component onto the moving substrate. At least a second transfer puck can be moved with the second rotatable drive member, and the second transfer puck can be configured to place a second discrete component onto the moving substrate. A first electronic drive can be connected to the first servo motor, and the first electronic drive can be configured to selectively move the first transfer puck at a first pick up speed and at least a second deposit speed. At least a second electronic drive can be connected to the second servo motor, and the second electronic drive can be configured to selectively move the second transfer puck at the first pick up speed and at the second deposit speed.

In a particular aspect, the transfer method and apparatus of the invention can further include a third rotatable drive member which is substantially coaxial with the first drive member. A third servo motor can be connected to rotate the third drive member, and a third transfer puck can be or driven by the first rotatable drive member. A third electronic drive can be connect to the third servo motor, and the third electronic drive can be configured to selectively move the third transfer puck at the first pick up speed and at the second deposit speed.

In another aspect, the method and apparatus may include any desired number of transfer segments. Each transfer segment can include a selected drive member; a servo motor connected to its corresponding drive member; an electronic drive connected to its corresponding servo motor; and a transfer puck which is operatively actuated to move at the first pick up speed and at least the second deposit speed. Further aspects of the method and apparatus can include a providing of a component web, and a dividing of the component web into discrete components. The component web can be delivered to the dividing operation at the first pick up speed, and the discrete components can be applied onto the moving substrate at the different, deposit speed.

By incorporating its various features and aspects, the method and apparatus of the invention can more efficiently and more accurately change the speed of a discrete component or component for placement onto a continuously moving web. The various configurations of the invention can provide an improved ability to generate greater changes in speed and to maintain the desired speeds for selected durations of time. The present invention can provide a distinctive, variable speed method and apparatus which has less mechanical complexity, and can more accurately and more reliably provide the different speeds over selected dwell periods or other dwell quanta. As a result, the present invention can provide a more precise control of the length and placement of the discrete component onto the moving web.

### BRIEF DESCRIPTION OF THE DRAWINGS

The present invention will be more fully understood and further advantages will become apparent when reference is made to the following detailed description of the invention and the accompanying drawings wherein like numerals represent like elements. The drawings are merely representative and are not intended to limit the scope of the appended claims.

FIG. 1 shows a schematic, perspective view of a representative method and apparatus that can incorporate the present invention;

FIG. 2 shows a schematic, side elevational view of a representative method and apparatus that can incorporate the present invention; FIG. 3 shows a schematic, perspective view of a representative variable-speed transfer device that can incorporate the method and apparatus of the invention;

FIG. 4 representatively shows a schematic, partial end view of a variable-speed transfer device that can incorporate the method and apparatus of the invention;

FIG. 5 representatively shows a perspective view of another representative, variable-speed transfer device that can incorporate the method and apparatus of the invention;

FIG. 6 representatively shows a schematic, perspective view of another representative, configuration of the variable-speed transfer device that can incorporate the method and apparatus of the invention;

FIG. 7 representatively shows a schematic, perspective view of a variable-speed transfer device that has been arranged to place discrete components at spaced apart locations along side edges of a moving substrate;

FIG. 8 representatively shows a schematic, end view of a variable-speed transfer device that has been arranged to place discrete components at spaced apart locations along a moving substrate;

FIG. 9 representatively shows a schematic, perspective view of a variable-speed transfer device that has been connected to electronic drive systems that can be operatively controlled with computer hardware and associated software;

FIG. 10 representatively shows a partially cross-sectioned, end view of a system of transfer pucks which are rotatably mounted on a shaft, and driven by an array of coaxially arranged drive members having the configuration of drive pulleys;

FIG. 11 representatively shows a pair of cooperating drive pulleys that have been configured with an operative arrangement of through-slots and drive tang-members;

FIG. 12 representatively shows an view of a cross-section through a drive pulley that is connected to its corresponding transfer puck;

FIG. 13 representatively shows an view of a cross-section through a cooperating pair of drive pulleys, each of which has been connected to its corresponding transfer puck;

FIG. 14 representatively shows a perspective, exploded view of a system of drive pulleys, rotatable puck-supports, and vacuum-control components that can be coaxially mounted with a support shaft;

FIG. 15 representatively shows a side view of a cross-section through a portion of a transfer puck and its associated vacuum-delivery and vacuum-control components;

FIG. 16 representatively shows a view of a cross-section through system pair of coaxially arranged vacuum-control shafts and corresponding adjustment flanges;

FIG. 17 shows a representative diagram plot of a speed or velocity profile;

FIG. 17A shows a representative table of data employed to determine the speed or velocity profile illustrated in FIG. 17;

FIG. 17B shows a representative table of data employed to determine the portions of the motion-area that lie under the corresponding parts of the speed profile illustrated in FIG. 17;

FIG. 18 shows a representative diagram plot of another speed profile which incorporates an irregular acceleration curve, and an irregular deceleration curve.

### DETAILED DESCRIPTION OF THE INVENTION

The present disclosure will be expressed in terms of its various components, elements, constructions, configurations and arrangements that may also be individually or collectively be referenced by the terms, “aspect(s)” of the invention, feature(s) of the invention, or other similar terms. It is contemplated that the various forms of the disclosed invention may incorporate one or more of its various features and aspects, and that such features and aspects may be employed in any desired, operative combination thereof.

It should also be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

The present invention can provide a distinctive transfer apparatus and method for changing a movement speed one or more discrete components. In a particular feature, the invention can provide a distinctive transfer apparatus and method for substantially continually receiving one or more discrete components that are traveling at a first speed, and applying the components to a substrate web that is traveling at a different, second speed. The apparatus and method can, for example, be particularly useful for receiving discrete components having an elastomeric material, such as leg elastics, waist elastics, or elasticized panels, and applying the components to a moving product web. Each discrete component may be a single element or may be a composite having two or more elements. The product web can be arranged to provide an interconnected plurality of intended articles, and the intended, final articles may be disposable absorbent articles. For example, the absorbent articles may be disposable diapers, children's training pants, feminine care products, adult incontinence products and the like. The discrete component or components may, for example, include waist elastics, leg elastics, tapes, snaps, flaps, patches of material, hook and loop materials, or the like. The discrete components may be composed of a single material or a combination of materials. The materials may be elastomeric or non-elastomeric, and may have any desired configuration of physical and/or chemical properties. Additionally, each component may include a single element, or may include a composite or assembly of elements.

The process and apparatus of the invention can have an appointed machine-direction 26 which extends longitudinally, and an appointed cross-direction 28 which extends laterally or transversely. For the purposes of the present disclosure, the machine-direction 26 and is the direction along which a particular component or material is transported length-wise along and through a particular, local position of the apparatus and method. The cross-direction 28 lies generally within the plane of the material being transported through the process, and is aligned perpendicular to the local machine-direction 26.

With reference to FIGS. 1 through 4, a representatively shown transfer method and apparatus 20 for changing a speed of discrete components 22 can include a first rotatable drive member, such as provided by a first drive shaft 32, and can include at least a second rotatable drive member, such as provided by a second drive shaft 42. In a particular aspect, the method and apparatus can be configured to apply the discrete components 22 onto a moving substrate 24. The first drive member is substantially coaxial with the second drive member. Accordingly, the first drive shaft can be substantially coaxial with the second drive shaft. A first servo motor 34 can be connected to rotate the first drive member (e.g. drive shaft 32), and at least a second servo motor 44 can be connected to rotate the second drive member (e.g. drive shaft 42). A first transfer puck 36 is driven by the first rotatable drive member (e.g. shaft 32), and at least a second transfer puck 46 is driven by the second rotatable drive member (e.g. shaft 42). A first electronic drive 38 (e.g. FIG. 9) can be connected to the first servo motor 34, and the first electronic drive 38 can be configured to selectively move the first transfer puck 36 to provide a first, pick up speed V1, and at least a second, deposit speed V2. At least a second electronic drive 48 can be connected to the second servo motor 44, and the second electronic drive 48 can be configured to selectively move the second transfer puck 46 at the first pick up speed and at the second deposit speed. The deposit speed differs from the pick up speed, and may be greater or less than the pick up speed. In desired configurations, the deposit speed can be greater than the pick up speed.

The first transfer puck 36 can be carried or otherwise moved or driven by the first rotatable drive member. Similarly, the second transfer puck 46 can be carried or otherwise driven or moved by the second rotatable drive member.

The transfer apparatus of the invention can further include a third rotatable drive member, such as provided by a third drive shaft 52. The third drive member is substantially coaxial with the first drive member. Accordingly, the third drive shaft 52 can be substantially coaxial with the first drive shaft 32. A third servo motor 54 can be connected to rotate the third drive member (e.g. drive shaft 52), and a third transfer puck 56 can be carried or otherwise driven or moved by the third rotatable drive member. A third electronic drive 58 can be connect to the third servo motor 54, and the third electronic drive can be configured to selectively move the third transfer puck 56 at the first pick up speed V1 and at the second deposit speed V2.

In a process aspect of the invention, the transfer method for applying discrete components 22 onto a moving substrate 24 can include a rotating of a first rotatable drive member (e.g. drive shaft 32) with a first servo motor 34 and a providing of at least a second rotatable drive member (e.g. drive shaft 42) which is substantially coaxial with the first drive member. The second rotatable drive member (e.g. drive shaft 42) can be rotated with a second servo motor 44. A first transfer puck 36 can be moved with the first rotatable drive member (e.g. drive shaft 32), and the first transfer puck 36 can be configured to place a first discrete component 22 onto the moving substrate 24. At least a second transfer puck 46 can be moved with the second rotatable drive member (e.g. drive shaft 42), and the second transfer puck 46 can be configured to place a second discrete component onto the moving substrate. A first electronic drive 38 can be connected to the first servo motor 34, and the first electronic drive 38 can be configured to selectively move the first transfer puck 36 at a first pick up speed and at least a second deposit speed. At least a second electronic drive 48 can be connected to the second servo motor 44, and is the second electronic drive 48 can be configured to selectively move the second transfer puck 46 at the first pick up speed and at the second deposit speed.

In a further feature, the method can include a third servo motor 54 which is operatively connected to rotate a third rotatable drive member (e.g. drive shaft 52) which is positioned substantially coaxial with the first drive member (e.g. drive shaft 32). A third transfer puck 56 can be carried with, otherwise moved or driven by the third rotatable drive member, and a third electronic drive 58 can be operatively connected to the third servo motor 54. The third electronic drive 58 can be configured to selectively move the third transfer puck 56 at the first pick up speed and at least the second deposit speed.

In another aspect, the method and apparatus may be configured to include any desired number of transfer segments and associated pucks, depending upon the different web speeds and the desired placement and size of the discrete components 22. Accordingly, each transfer segment can include a selected drive member; a servo motor connected to its corresponding drive member; an electronic drive connected to its corresponding servo motor; and a transfer puck which is connected to its corresponding drive member and is operatively driven or otherwise actuated to move at the first pick up speed and at least the second deposit speed. With respect to each transfer segment, the corresponding transfer puck can periodically move at the pick up speed along a selected pick up location which extends through an appointed receiving zone, and can periodically move at the deposit speed along a selected deposit location which extends through an appointed application zone.

In still another aspect, the method and apparatus can include a high-resolution control system that can finely regulate and coordinate the motions of the individual transfer pucks. The high-resolution control system can operatively synchronize the motions of the transfer pucks, and can substantially avoid an undesired hitting or clashing between the transfer pucks.

By incorporating its various features and aspects, the method and apparatus of the invention can more efficiently and more accurately change the speed of a discrete component or component for placement onto a continuously moving web. The method and apparatus can distinctively employ a plurality of individual transfer segments, each of which is individually driven by a separately provided servo system. The various configurations of the invention can provide an improved ability to generate greater changes in speed and to maintain the desired speeds for selected intervals, such as selected durations of time. The present invention can provide a distinctive, variable speed method and apparatus which has less mechanical complexity. The technique of the invention can have a relatively smaller number of moving parts, and can avoid the use of complex linkages and complex gear boxes. As a result, the method and apparatus that incorporates the present invention can be more readily changed to accommodate the production of different configurations of a manufactured article, and the changes can be made at lower cost. The invention can be configured to provide a reduced amount of rotational run-out and deflection. As a result, the technique of the invention can better accommodate an ultrasonic bonding operation of the discrete components, and can better accommodate a cutting operation that is performed directly on the transfer pucks. Additionally, the invention can more accurately and more reliably provide the different speeds over selected dwell times or other dwell intervals. For example, each transfer puck can dwell at the pick up speed for a complete product cycle that is substantially matched to an article length 104 of the moving substrate 24. This operation can thereby provide a substantially matched in-feed speed that can better accommodate the transfer and placement of curved components. The matched in-feed can also better accommodate an intermittent, spaced-apart placement of irregular-shaped or odd-shaped components. As a result, the present invention can provide a more precise control of the length and placement of the selected discrete component 22 onto the moving web 24. In contrast to prior attempts to incorporate individual servo drives in a multi-segment, variable speed transfer system, the disclosed method and apparatus can better avoid clashing or other damaging contact between the moving transfer segments

As representatively shown, an operative transport mechanism, such as provided by a suitable system of transport rollers 30, can be configured to move the substrate 24 at a selected speed. In a desired configuration, the transport mechanism can be arranged to move the substrate substantially at the selected deposit speed, V2.

To provide the desired transport operations needed by the various configurations of the invention, any suitable transport mechanism may be employed. Such transport mechanisms can, for example, be provided by transport rollers, conveyor belts, pneumatic conveyors, vacuum conveyors or the like, as well as combinations thereof.

In a desired aspect, the substrate 24 can be provided by a product web, and the product web may be a composite web assembled from two or more parts. The product web may, for example, be employed to form individual absorbent articles, such as disposable diapers. The product web may include a substantially liquid-impermeable backsheet layer, a liquid permeable topsheet layer and a series of absorbent cores sandwiched between the backsheet and topsheet layers. Accordingly, the substrate web can operatively define an interconnected plurality of article lengths or article segments 104.

A selected component web 92 can be delivered from a suitable web supply 90, and the component web can be delivered to the location of the transfer pucks while the component web is moving substantially at the pick up speed V1. In a desired configuration, a suitable cutter mechanism can divide the incoming component web 92 into individual pieces or discrete components 22 for subsequent transport by the transfer pucks 36, 46 and 56. Accordingly, the component web can be delivered to a cutter 70 while the component web is moving at substantially the pick up speed V1. In a desired feature, the cutting or other dividing operations can be configured to occur during the course of delivering and placing the desired, machine-directional lengths of the component web 92 on the outward surface of the individual transfer pucks. Each of the resulting discrete components 22 can then be applied to the moving substrate 24. A suitable cutter mechanism can, for example, be provided by a rotary knife, a rotary die cutter, a laser cutter, a particle-beam cutter, an ultrasonic cutter, a water cutter or the like, as well as combinations thereof.

It should be apparent that in alternative configurations of the invention, the continuous component web 92 and the cutter 70 may be omitted, and that other techniques for generating and providing the discrete components 22 may be employed. In addition, it should be apparent that the discrete components 22 may be secured to the second substrate web 24 by employing a suitable securement, such as an adhesive applied in a selected pattern to a surface of the discrete components 22. Any other securement mechanism for attaching the discrete components 22 to the substrate web 24 may also be employed. Such securement mechanisms can, for example, include pins, staples, rivets, sewing, thermal bonds, ultrasonic bonds, welds, cohesives, adhesives, stitching or the like, as well as combinations thereof.

The method and apparatus of the invention can include any suitable support frame 120, and the support frame can be constructed in any suitable manner. In a desired arrangement, the technique of the invention can receive the component web 92 traveling at a first speed in the machine-direction, can sever the component web 92 into a selected plurality of discrete components 22 and can apply the discrete components 22 to a substrate web 24 that is traveling at a different, second speed. It should be readily understood that the invention may be configured to include any desired number of transfer segments and associated pucks, depending upon the different web speeds and the desired placement and size of the discrete components 22. As illustrated in the representatively shown example, the method and apparatus 20 can include three transfer segments. Optionally, four or more transfer segments may be employed. In desired aspects, each transfer segment can include a corresponding drive member (e.g. drive shafts 32, 42, 52); a corresponding servo motor (34, 44, 54, respectively); a corresponding electronic drive (38, 48, 58, respectively); and a corresponding transfer puck (36, 46, 56). Additionally, each transfer segment can include a corresponding, rotary drive arm member (40, 50, 60, respectively); and a corresponding, rotary support member (84, 86, 88, respectively). The rotatable drive arm members and rotatable support members can have any operative configuration, such as rod-shaped, beam-shaped, pie-shaped, crescent-shaped, wheel-shaped, ring-shaped or the like, as well as combinations thereof. Each transfer puck can be configured to receive and apply the discrete components 22, and can be configured to be rotated or otherwise moved around a selected drive axis, such as the representatively shown drive axis 106. Accordingly, each transfer puck can operatively orbit around the drive axis. Additionally, the orbit of the transfer puck can follow a substantially circular path. In a desired configuration, each transfer segment can be configured to be operatively similar to some or all of the other transfer segments. Accordingly, the arrangements, structures features, operational features or other configurations that are described with respect to a particular transfer segment may also be incorporated by the other transfer segments.

The first rotatable drive shaft 32 can be coaxially aligned with the drive axis 106. A first drive member, such as provided by the representatively shown first arm member 40, can be operatively connected and joined to the first drive shaft. As representatively shown, the arm member 40 can be fixedly joined to the first drive shaft 32 to project radially away from the first drive shaft, and can be configured to have any operative length. The first transfer puck 36 can be configured to carry and deliver a first discrete component 22 for placement onto the moving substrate, and can be operatively connected and joined to a distal end of the arm member 40. The transfer puck 36 can also be operatively connected and joined to a first support member 84. The first support member can have any operative length which is suitable for maintaining a desired positioning and orientation of its corresponding transfer puck 36. In a desired configuration, the first support member can be aligned generally parallel to the first drive arm 40, and can be configured to hold an outward surface 108 of the transfer puck in a position that is aligned substantially parallel to the drive axis 106. Optionally, the method and apparatus of the invention can be constructed to maintain other alignments of the transfer puck, as desired. The support member 84 can extend substantially radially from an idler, support shaft 74, which may be a solid shaft or a hollow shaft, as desired. The support shaft 74 can be suitably constructed, mounted and otherwise configured to be substantially, coaxially aligned with the drive axis 106. Additionally, the support member 84 can be rotatably mounted on the support shaft 74 with any suitable bearing. Such rotatable bearings are well known in the art.

Where the method and apparatus of the invention includes two or more transfer segments, the second rotatable drive shaft 42 can be co-axially aligned with the first drive shaft 32, and in a particular feature, the first rotatable drive shaft 32 and at least the second rotatable drive shaft 42 can be configured to be substantially concentric. The second arm member 50 can be operatively connected and joined to the second drive shaft. As representatively shown, the arm member 50 can be fixedly joined to the second drive shaft 42 to project generally radially away from the second drive shaft, and can be configured to have any operative length. The second transfer puck 46 can be configured to carry and deliver at least a second discrete component for placement onto the moving substrate 24, and can be operatively connected and joined to a distal end of the arm member 50. Additionally, the transfer puck 46 can be operatively connected and joined to a second support member 86, and the second support member can have any operative length that is suitable for maintaining the desired positioning and orientation of its corresponding transfer puck 46. As representatively shown, the second support member can be aligned generally parallel to the second drive arm member 50, and can be configured to hold the outward surface 108 of the transfer puck in a position that is aligned substantially parallel to the drive axis 106. The support member 86 can extend substantially radially from the support shaft 74. Additionally, the support member 86 can be rotatably mounted on the support shaft 74 with any suitable, rotatable bearing.

In the representatively shown configuration, the second drive shaft 42 can extend axially beyond a terminal end of the first drive shaft 32, and can extend axially beyond the first drive arm member 40. As a result, the second drive arm member 50 can be located axially adjacent the first drive arm member 40. Additionally, the second rotatable support member 86 can be positioned axially adjacent the first rotatable support member 84.

In a desired configuration, a third rotatable drive shaft 52 can be co-axially aligned with the first drive shaft 32, and can also be co-axially aligned with the second drive shaft 42. In a particular feature, the third rotatable drive shaft 52 and the first drive shaft 32 can also be substantially concentric. Additionally, the second rotatable drive shaft 42 and the third rotatable drive shaft 52 can be substantially concentric. The third arm member 60 can be operatively connected and joined to the third drive shaft. As representatively shown, the arm member 60 can be fixedly joined to the third drive shaft 52 to project generally radially away from the third drive shaft, and can be configured to have any operative length. The third transfer puck 56 can be configured to carry and deliver a third discrete component for placement onto the moving substrate, and can be operatively connected and joined to a distal end of the arm member 60. The transfer puck 56 can also be operatively connected and joined to a third support member 88, and the third support member can have any operative length which is suitable for maintaining the desired positioning and orientation of its corresponding transfer puck 56. In the representatively shown arrangement, the third support member can be aligned generally parallel to the third drive arm member 60, and can be configured to hold the outward surface 108 of the transfer puck in a position that is aligned substantially parallel to the drive axis 106. The support member 88 can extend substantially radially from the support shaft 74. Additionally, the support member 88 can be rotatably mounted on the support shaft 74 with any suitable, rotatable bearing.

In the representatively shown configuration, the third drive shaft 52 can extend axially beyond a terminal end of the second drive shaft 42, and can extend axially beyond the second drive arm member 50. As a result, the third drive arm member 60 can be located axially adjacent the second drive arm member 50. Additionally, the third rotatable support member 88 can be positioned axially adjacent the second rotatable support member 86.

Each drive shaft can be operatively connected to its corresponding servo motor. With regard to the first transfer segment, the first drive shaft 32 may be directly driven by the first servo motor 34, or may be driven by employing a selected transmission system. In the representatively shown configuration, for example, the transmission system can include a drive shaft wheel (e.g. a drive shaft gear) which is operatively connected and joined to the drive shaft, a motor wheel (e.g. a motor gear 112) which is operatively connected to the servo motor, and a corresponding drive belt 114 which operatively interconnects between the drive shaft gear and motor gear. As shown in the example of the illustrated arrangement, the drive shaft gearing device can include the representatively shown drive pulley 118. The drive belt 114 can, for example, be a drive chain, a toothed belt or the like. Accordingly, the transmission system can be constructed to provide an accurately-following, substantially non-slip coupling between the drive shaft 32 and its associated servo motor 34.

In a similar fashion, the second drive shaft 42 may be directly driven by its corresponding servo motor 44 or may be driven by employing a selected transmission system. Additionally, the third drive shaft 52 may be directly driven by its corresponding servo motor 54 or may be driven by employing a selected transmission system. The transmission system between the second drive shaft 42 and the second servo motor 44 can similarly include a second shaft wheel (e.g. shaft pulley 118a), a second motor wheel (e.g. motor gear 112a) and a second drive belt 114a. In a like configuration, the transmission system between the third drive shaft 52 and the third servo motor 54 can include a third shaft wheel (e.g. shaft pulley 118b), a third motor wheel (e.g. motor gear 112b) and a third drive belt 114b.

In the various components or other aspects of the invention that incorporate a transmission system, it should be readily appreciated that any conventional transmission device or system may be employed. Such transmissions can, for example, include mechanically coupled systems, electronically coupled systems, hydraulically coupled systems, interengaging gear systems, belt and pulley systems, transmission gears, transmission chains and the like, as well as combinations thereof.

Each servo motor can be operatively held by a motor mount which is suitably assembled and attached to the support frame 120. In particular, the first servo motor 34 can be operatively held by a motor mount 122; the second servo motor 44 can be operatively held by a motor mount 122a; and the third servo motor 54 can be operatively held by a motor mount 122b.

As representatively shown, each servo motor can be an electric motor, and a corresponding electronic drive can be operatively connected to power and control each servo motor. In particular, the first servo motor 34 can be actuated and regulated by the first electronic drive 38; the second servo motor 44 can be actuated and regulated by the second electronic drive 48; and the third servo motor 54 can be actuated and regulated by the third electronic drive 58.

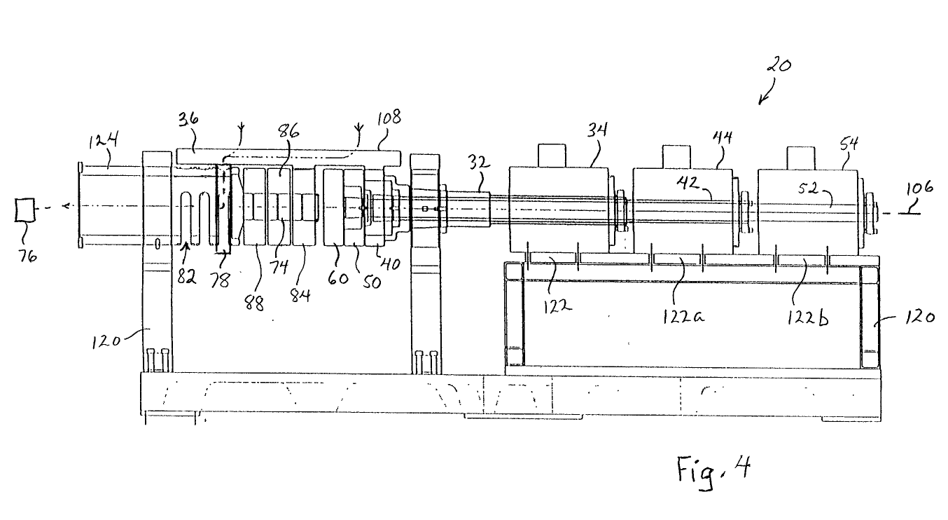

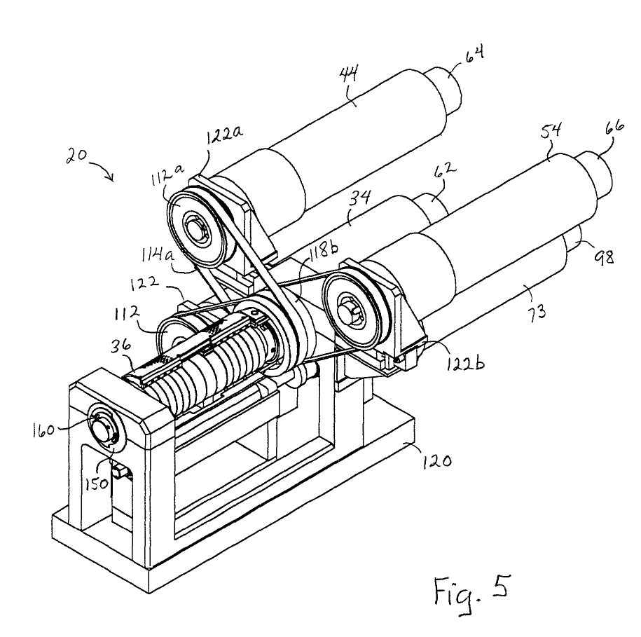

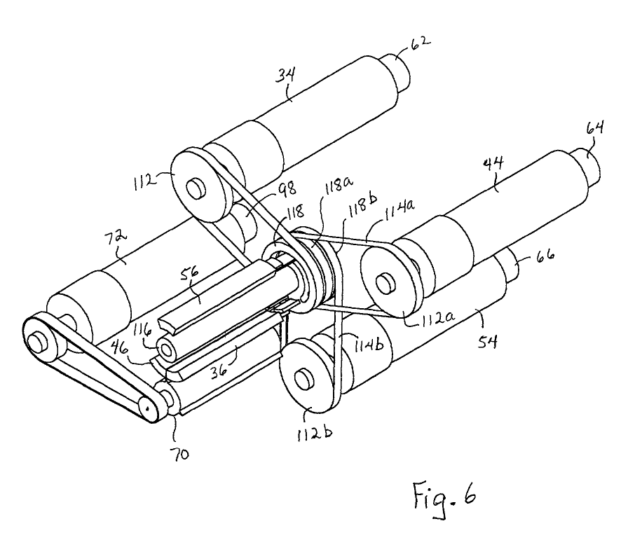

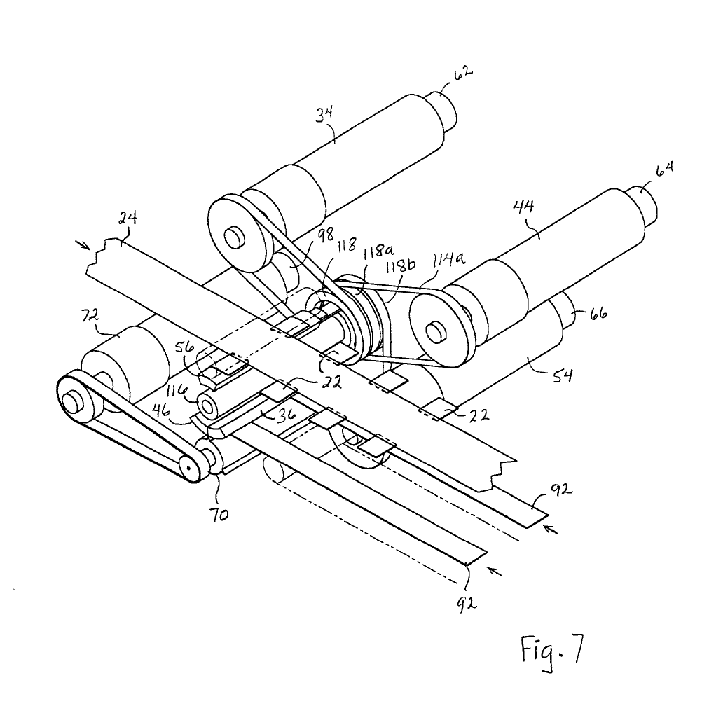

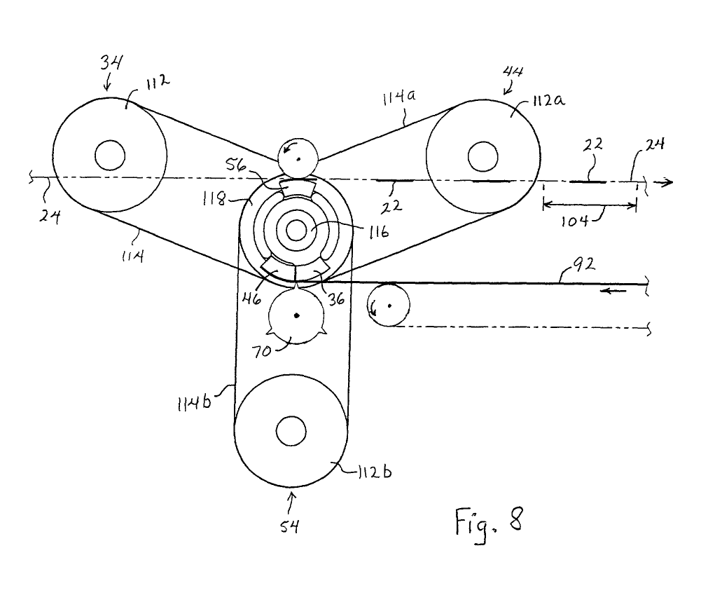

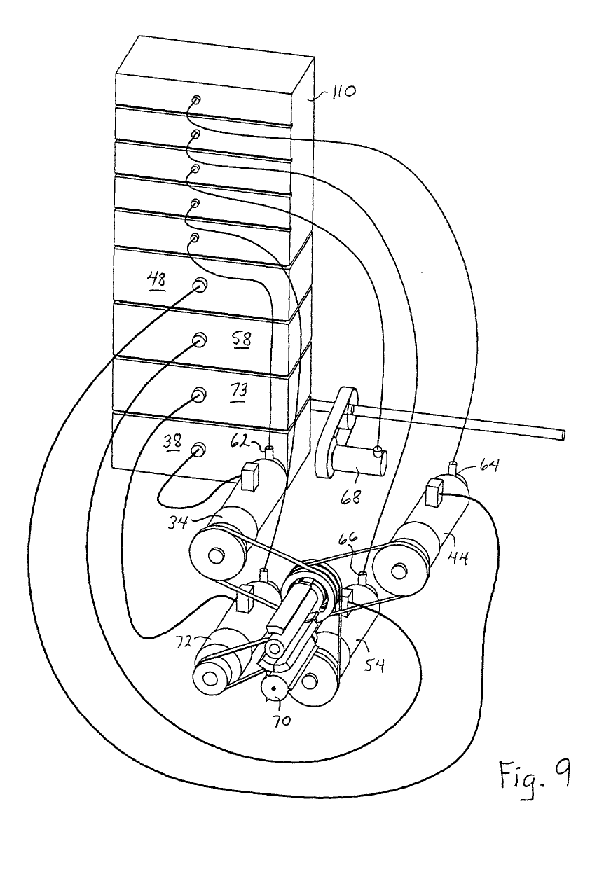

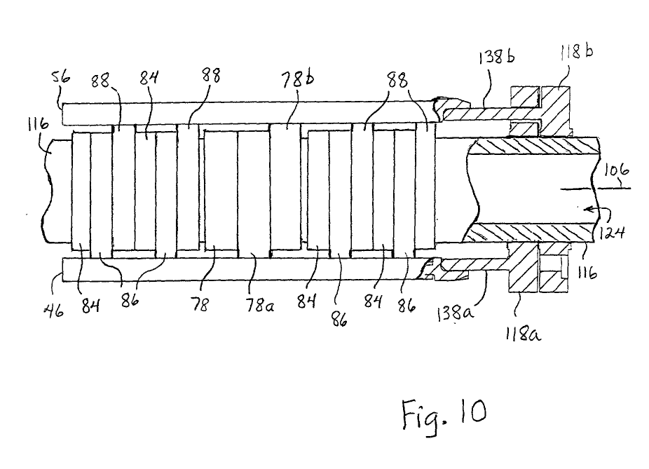

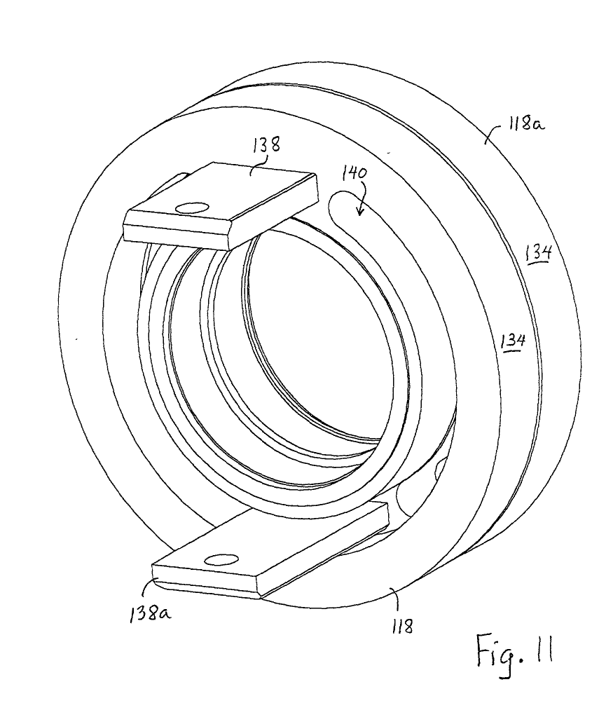

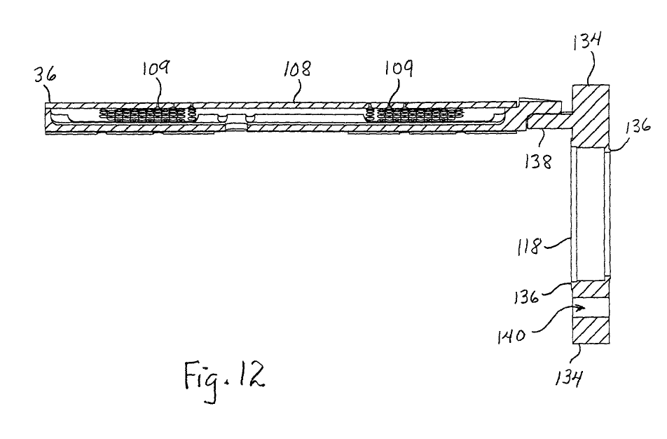

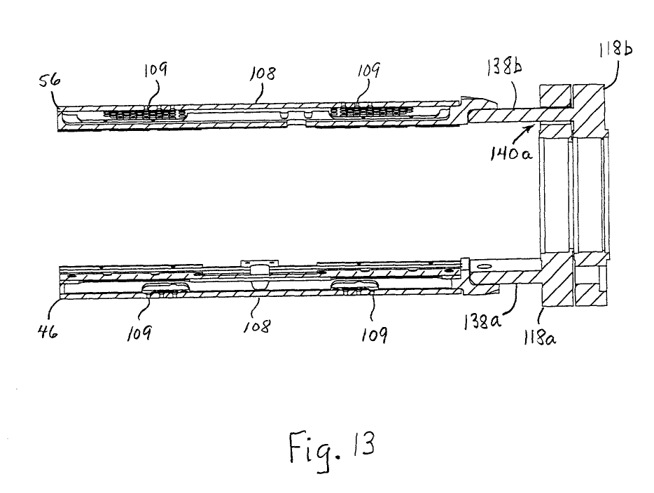

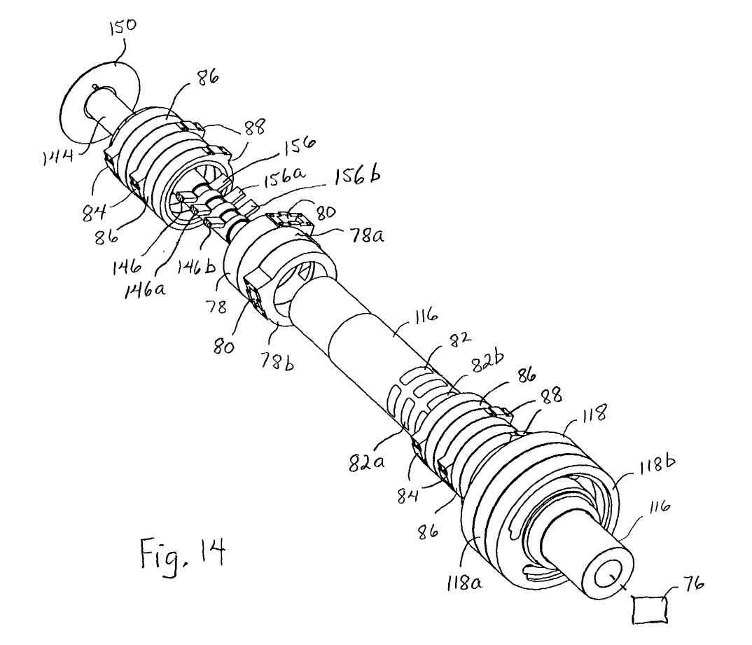

With reference to FIGS. 1 and 5 through 9, each of the servo motors can be held by a corresponding motor mount 122, and the servo motors can be distributed in an arrangement that extends generally circumferentially around the drive axis 106. Alternatively, the servo motors may be mounted and arranged to the generally longitudinally aligned along the drive axis 106 (e.g. FIGS. 3 and 4). Optionally, the servo motors can be configured with a combination of the axially aligned or circumferentially distributed arrangements.

Each transfer puck (36, 46, 56) may have any operative size and shape, and the size and shape can be selected to operatively handle the size and shape of the discrete component being transferred by the puck. As representatively shown, the transfer puck may have terminal edge boundaries that form a generally rectangular shape. Additionally, each transfer puck can be a hollow member, and can have an outer surface 108. In a desired aspect, the outer surface can have a contour that substantially corresponds to a portion of a cylindrical surface. The dimensions of the transfer pucks can vary, depending upon the desired number of transfer pucks employed, and the size and shape of the discrete components 22 being transferred. For example, when the technique of the invention includes three transfer pucks, each transfer puck may have an outer peripheral, circumferential arc length span that subtends an angle which is within the range of about 20° to about 105°. Additionally, each transfer puck can have cross-directional width which is within the range of about 5 cm to about 40 cm.

In a particular aspect, the outer surface 108 of each transfer puck may also be configured to turn its associated discrete component 22 before the discrete component 22 is applied to the moving substrate 24. For example, the outer surface 108 of each transfer puck 108 may be connected to an operative turning system which is configured to twist about a pivot axis. The pivot axis can, for example, be generally radially aligned, and can extend substantially perpendicular to the drive axis 106. Any mechanism which provides the desired turning of the components 22 may be employed. For example, one suitable mechanism is a barrel cam, which is well known to those skilled in the art. Thus, in use, the discrete components 22 may be received by the transfer puck while oriented in one direction and, subsequently, may be pivoted by the turning mechanism before being applied to the substrate 24. The turning mechanism can be configured to pivot the discrete components 22 any desired amount. For example, the turning mechanism may be configured to pivot the components 22 from about 1 degree to about 180 degrees, and desirably can pivot the discrete components from about 1 degree to about 90 degrees, depending upon the desired orientation of the components 22 on the substrate 24. Such a turning mechanism can be particularly useful when applying waist elastics to a product web composed of interconnected disposable absorbent articles.

To assist in maintaining the discrete components 22 on the outer surface 108 of each transfer puck, the method and apparatus can include an operative, releasable holding mechanism, such as provided by a high-friction surface, a latching system, a mechanical clamping system, an electrical clamping system, magnetic clamping system, a system of pins, a vacuum suction system, an adhesive system, a system of holding magnets, an electromagnetic holding system or the like, as well as combinations thereof.

In a particular feature, the outer surface 108 of each transfer puck may be textured to define a surface roughness which can assist in gripping and maintaining the discrete components 22 on the outer surface 108. Such a configuration can be particularly desirable when the discrete components 22 are elongated elastic segments. As used herein, the term “surface roughness” is the surface roughness of a material as determined by conventional methods known to those skilled in the art. For example, one such method utilizes a profilometer to detect the surface roughness. The stylus of the profilometer is drawn across the textured surface a distance of 1.27 centimeters. The profilometer measures the number of peaks and valleys on the surface as well as the magnitude of each. The profilometer automatically calculates the surface roughness as a Roughness Average (Rₐ) which is the arithmetic average of the measured profile height deviations taken within the sampling length and measured from the graphical centerline. The outer surface 108 of each transfer puck may define a surface roughness of at least about 3 micrometers, desirably at least about 10 micrometers and more desirably at least about 15 micrometers. For example, the outer surface 108 may have a surface roughness which can be from about 5 micrometers to about 50 micrometers, and desirably, can be from about 10 micrometers to about 20 micrometers. To achieve the surface roughness, the outer surface 108 of each transfer puck may also include a coating, such as a plasma coating, as known to those skilled in the art. In a particular aspect wherein the discrete components 22 being received and applied by the transfer puck are elongated elastic components, the outer surface 108 can have a plasma coating which defines a surface roughness of at least about 5 micrometers.

In another feature, a vacuum suction system 76 may be employed to temporarily and releasably hold the discrete component 22 on each transfer puck. With the vacuum system, the outer surface of the puck may include a plurality of small apertures or holes through which a relatively low pressure or vacuum can be drawn. The number and pattern of the holes may vary depending upon: the size of the particular transfer puck; the shape and size of the discrete components 22; and the desired location of the discrete components 22 on the transfer puck. When the outer surface 108 of the particular puck is textured and rough, a relatively small amount of vacuum can be sufficient to maintain the discrete component 22 on the outer surface. For example, the vacuum level can be not more than about 20 inches of water, and desirably, can be within the range of about 1 inch to about 10 inches of water. It has been discovered that, when compared to conventional methods which use relatively high levels of vacuum to grip the components, the combination of the rough outer surface 108 and the relatively low level of vacuum of the apparatus of the present invention can provide improved control and placement of the is discrete components 22 on the substrate web 24 at a relatively lower cost.

The desired vacuum may be drawn through the holes in the outer surface 108 of the transfer puck by any conventional technique for drawing a vacuum. Such techniques are known to those skilled in the art. The vacuum to each transfer puck may be controlled such that a vacuum is only being drawn from the outer surface 108 of each transfer puck for the period of rotation during which the discrete component 22 is located on the outer surface 108 of its associated transfer puck. In a particular feature, the vacuum may be activated just prior to receiving the discrete component 22, and may be inactivated immediately after applying the discrete components 22 to the moving substrate 24.

The vacuum device can include a vacuum conduit which is connected in an operative communication with the transfer pucks. Additionally, the vacuum conduit can be operatively connected to any suitable vacuum source 76. For example, the vacuum source may be provided by a system which includes a conventional vacuum pump or suction fan. With reference to FIG. 4, the support shaft 74 can be connected and joined to the vacuum conduit 124. In a particular configuration, the vacuum conduit 124 can be mounted on the support frame 120 and the support shaft 74 can be mounted on the vacuum conduit. For example, the support shaft 74 can be fixedly connected to a terminal, axial end of the vacuum conduit 124. Additionally, the vacuum conduit 124 can be substantially co-axially aligned with the support shaft 74. As representatively shown, the vacuum conduit 124 can have a substantially cylindrical cross-sectional shape.

In a particular aspect, the method and apparatus of the invention can include segmented and timed vacuum manifolds hold the individual components 22 on their corresponding transfer pucks. With reference to FIGS. 3 and 4, the segmented vacuum can be provided by employing a stationary, hollow vacuum conduit 124. The desired vacuum can be distributed to an individual transfer puck through a system of one or more thick, low-friction rings 78. One or more rings 78 can be attached to each transfer puck to segment the vacuum to that individual puck. The rings 78 encircle the vacuum conduit 124 and provide an operative seal between the shaft 74 and the corresponding transfer puck. The rings 78 can include radial holes or slots 80 (e.g. FIG. 14), or other types of openings, and the shaft 74 can include holes or slots 82, or other cooperative openings. The ring slots 80 and the shaft slots 82 can provide an operative path for the vacuum to access their corresponding transfer puck. The desired timed vacuum can be provided by positioning the shaft slots 82 in a manner which allows vacuum to flow through the ported rings 78 at desired transfer portions of the rotational movement of the transfer puck along its predetermined rotational path. Areas of the shaft 74 which do not include slots 82 can be arranged to keep the vacuum shut off in the portions of the transfer puck motion during which a discrete component 22 is not intended to be carried by the transfer puck.

The outer surface 108 of each transfer puck can be configured to travel along a predetermined circumferential path that allows the discrete components 22 to be received and applied to the moving substrate 24. As representatively shown, the outer surface 108 of each transfer puck can be configured to travel along a common, orbital path. Accordingly, the orbital path for each transfer puck can be substantially the same as the orbital path of the other transfer pucks. During each revolution of a particular transfer puck around the drive axis 106, the outer surface 108 can receive at least one discrete component 22 while moving at the first, pick up speed, and can change speed to apply the discrete component 22 to the moving substrate 24 while moving at the second, deposit speed. For example, the method and apparatus of the present invention can be configured such that each transfer puck can apply a complementary pair of discrete components 22 onto the moving substrate 24 during each revolution of that transfer puck.

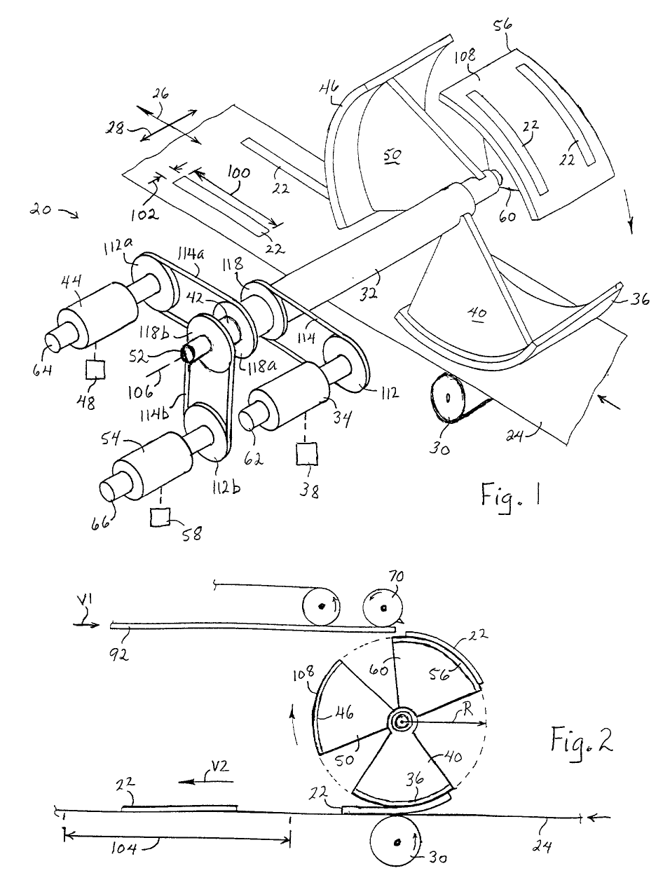

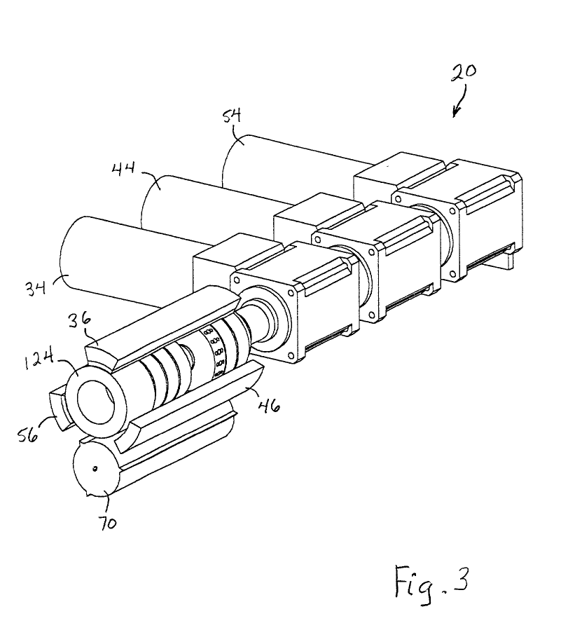

Each transfer puck (36, 46, 56) and its corresponding arm member (30, 40, 50, respectively) can provide a radial length R (e.g. FIG. 2), as determined from the drive axis 106 to the outer peripheral surface 108 of the transfer puck. Any operative radial length may be employed. In particular configurations, the radial arm length can be at least a minimum of about 5 cm, and alternatively, can be at least about 12 cm. In another feature, the radial length can be up to a maximum of about 150 cm, and alternatively, can be up to about 25 cm to provide desired performance.

With reference to FIGS. 5, 6, 7, 8 and 10, a particular aspect of the invention can include a substantially stationary shaft 116, and a system of drive members which are rotatably mounted on the stationary shaft 116. Suitable, rotatable drive members can be provided by arm members, lobed members, gears, disks, wheels or the like, as well as combinations thereof. In a desired arrangement, the drive wheels can be provided by a plurality of drive pulleys 118 rotatably mounted on the shaft 116.

With reference to FIGS. 11 and 12, each drive pulley 118 can include an outer peripheral surface 134 and an axially projecting tang member 138 which is attached to the drive pulley 118 at a position which is radially spaced away from a rotational axis of the drive pulley. In addition, the drive pulley 118 can include bosses 136 which can increase the axial length of the rotational bearing surface of the drive pulley. The drive pulley can also include a slot which extends through the axial thickness of the drive pulley, and extends around a pulley drive axis along at least a portion of a circumferential region of the pulley. In a desired configuration, the pulley slot 140 can be substantially circumferentially aligned with the pulley tang member 138. The extending tang member 138 is configured to operably engage a corresponding transfer puck, and the pulley slot 140 is configured to allow the extension and passage therethrough of a tang member that is connected and attached to another, adjacently positioned drive pulley (e.g. FIGS. 12 and 13).

With reference to FIGS. 10 through 13, a first drive pulley 118 can be rotatably mounted onto the support shaft 116, and a second drive pulley 118a can be rotatably mounted on the shaft 116 in a position that is axially adjacent the first drive pulley. The tang member of the second drive pulley 118a is arranged to extend through the pulley slot 140 of the first drive pulley 118. The tang member 138 of the first drive pulley 118 is configured to engage and operatively drive a corresponding transfer puck, such as the first transfer puck 36. Similarly, the tang member 138a of the second drive pulley 118a is configured to engage and operatively drive a corresponding transfer puck, such as the second transfer puck 46.

In a further aspect, a third drive pulley 118b can be rotatably mounted on the support shaft 116, and can be positioned axially adjacent the second drive pulley 11a. A tang member 138b, which is joined to the third drive pulley 118b, can be arranged to extend axially through the slot 140a in the second drive pulley 118a, and through the slot 140 of the first drive pulley 118. Additionally, the tang member 138b can be configured to engage and operatively drive a corresponding transfer puck, such as the third transfer puck 56.

It should be readily apparent that the materials employed to construct to the drive pulleys 118 (as well as the other components of the method and apparatus) should have sufficient strength and toughness to withstand the forces and stresses generated by driving their associated transfer pucks. Various conventional materials can be employed and are well known in the art.

Each transfer puck can be rotatably supported on the stationary shaft 116. As illustrated in the shown configuration, an arrayed system of puck support bearings can be rotatably mounted on the shaft 116. The puck supports and associated, rotatable bearings can be arranged in any operative array. In the shown configuration, the support bearings are arranged to support axially opposed end regions of their corresponding transfer puck. In the illustrated configuration, cooperating pairs of supports and associated bearings are connected to each end of each transfer puck. As representatively shown, support bearings 84 can be connected to the first transfer puck 36; support bearings 86 can be connected to the second transfer puck 46; and support bearings 88 can be connected to the third transfer puck 56.

With reference to FIGS. 10,14 and 15, the support shaft 116 can include a vacuum conduit 124 which is formed through the support shaft and extends along the lengthwise axial dimension of the support shaft to provide a desired vacuum-holding system. An array of vacuum slots 82, or other operative passageways, can be formed in the support shaft 116. The vacuum slots 82 can be configured to operatively communicate between the vacuum conduit 124 and the outer surface of the support shaft 116.

A system of seal rings 78 can be rotatably mounted onto the support shaft 116 to conduct the vacuum into the individual transfer pucks. As representatively shown, each seal ring 78 can include a slot 80 or other operative passage-opening therethrough. Each slot extends from an inner surface of the seal ring to the outer surface of the seal ring through the thickness thereof, and each slot 80 can be configured to provide an operative fluid communication between its corresponding transfer puck and its cooperatively associated slots 82 in the support shaft 116. In the representatively shown example, a first seal ring 78 can be operatively connected and attached to the first transfer puck 36; a second seal ring 78a can be operatively connected and attached to the second transfer puck 46; and a third seal ring 78b can be operatively connected and attached to the third transfer puck 56.

A particular aspect of the invention can include a control mechanism for regulating the timing of the vacuum directed into the individual transfer pucks. In a desired feature, the control mechanism can provide an operative, selective repositioning of the slot openings that extend radially through the hollow support shaft 116.

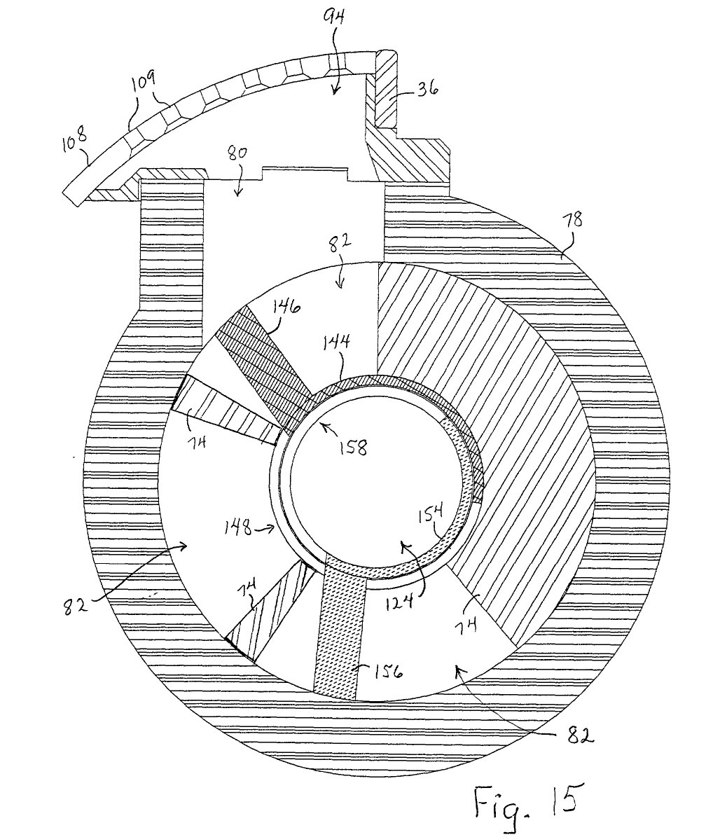

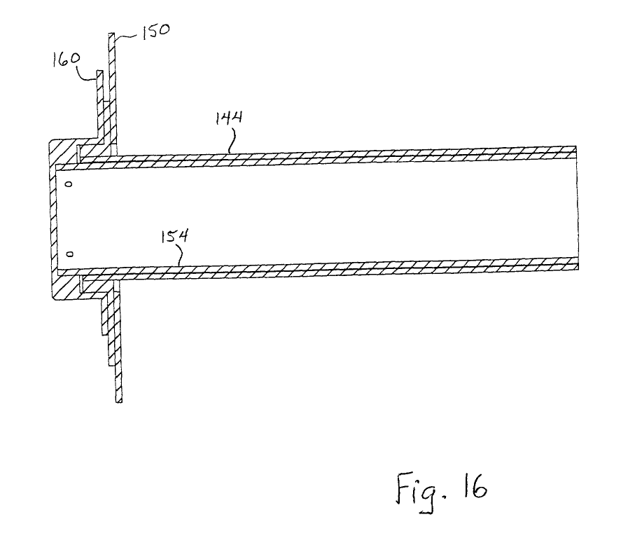

In the arrangement representatively shown in FIGS. 14, 15 and 16, the first seal ring 78 can be positioned and rotatably mounted in alignment with a first set of vacuum slots 82. Additionally, the second seal ring 78a can be positioned and rotatably mounted in alignment with a second set of vacuum slots 82a; and the third seal ring 78b can be positioned and rotatably mounted in an operative alignment with a third set of vacuum slots 82b.

The mechanism for adjusting the timing of the vacuum can include a first adjustment shaft 144 and a second adjustment shaft 154. As representatively shown, the first and second adjustment shafts can be hollow shafts, and the second adjustment shaft 154 can be configured to be substantially concentric with the first adjustment shaft 144. Additionally, the first adjustment shaft can be operatively mounted to be rotatable relative to the support shaft 116, and the second adjustment shaft can be operatively mounted to be rotatable relative to the first adjustment shaft.

The first adjustment shaft 144 can be configured to include an array of adjustment blades 146 which are attached or otherwise joined to the first adjustment shaft. The adjustment blades 146 extend radially from the first adjustment shaft, and have a blade width along the axial direction of the support shaft 116. The axial width of each blade 146 can be substantially equal to an axial width of the vacuum slot 82 with which the adjustment blade is cooperatively associated. The first adjustment shaft 144 can also include an array of shaft slots 148 which are positioned circumferentially adjacent the first adjustment blades 146 and extend from an inside surface of the first adjustment shaft 144 to an outer surface of the first adjustment shaft. When the first adjustment shaft 144 is assembled into the support shaft 116, the adjustment blades on the first adjustment shaft 144 can be operatively aligned with cooperating sets of the vacuum slots 82 that are provided in the support shaft 116. As illustrated in the representatively shown configuration, the adjustment blade 146 can be operatively aligned with the set of vacuum slots 82 in the support shaft 116; the adjustment blades 146a can be operatively aligned with the set of vacuum slots 82a; and the adjustment blade 146b can be operatively aligned with the set of vacuum slots 82b.

The second adjustment shaft 154 can be configured to be concentrically positioned inside the first adjustment shaft 144. An array of adjustment blades 156 can be attached or otherwise joined to the second adjustment shaft 154, and can be configured to extend radially from the second adjustment shaft. The blades 156 can have a blade width along the axial direction of the support shaft 116, and the axial width of each blade 156 can be substantially equal to an axial width of the vacuum slot 82 with which the adjustment blade is cooperatively associated. The second adjustment shaft 154 includes an array of vacuum slots 158 which are positioned circumferentially adjacent the second adjustment blades 156 and extend from an inside surface of the second adjustment shaft 154 to an outer surface of the second adjustment shaft. When the second adjustment shaft 154 is assembled into the first adjustment shaft 144, the adjustment blades 156 can be configured to extend through the adjustment slots 148 formed in the first adjustment shaft. Additionally, the second shaft slots 158 are suitably configured and arranged in a manner that allows at least a portion of the slots 158 to be selectively aligned with at least a portion the first shaft slots 148, and thereby regulate the duration of the vacuum applied to the individual transfer pucks.

The circumferential location and orientation of the vacuum slots 82 can also be circumferentially adjusted by turning the support shaft 116 around its axis to thereby help adjust the timing of the vacuum applied to the transfer pucks. Once the desired circumferential location is attained, the support shaft can be fixed at the desired position by employing any conventional holding mechanisms. Such holding systems are well known in the art.

To facilitate a positioning and assembly of the adjustment blades 146 and 156 into the desired cooperative arrangement with the vacuum slots 82, the adjustment blades 146 and 156 can be separately provided components that are suitably attached to their respective adjustment shafts 144 and 154 after the adjustment shafts have been inserted into a coaxial, concentric assembly with the support shaft 116. Any suitable attachment mechanism, such as bolts, pins, rivets, clamps or the like, may be employed. For example, screws may be employed to attach the adjustment blades to their respective adjustment shafts.

To adjust the duration of the applied vacuum, the adjustment shafts 144 and 154 can be operatively turned around the axis of the support shaft 116. To facilitate the turning of the individual adjustment shafts, a first adjustment flange 150 can be connected and attached to the first adjustment shaft 144, and a second adjustment flange 160 can be connected and attached to the second adjustment shaft 154. Once the desired rotational positioning of the first and second adjustment shafts have been set, the adjustment flanges can be operatively held and secured in position. Any operative holding mechanism may be employed. For example a system of screws, clamps or the alike may be employed.

The flanged ends of the adjustment shafts 144 and 154 are operatively plugged to prevent gas flow therethrough. Accordingly, when a vacuum source 76 is connected to the vacuum conduit 124 of the support shaft 116 a vacuum holding force may be applied at along the apertures 109. Accordingly, the path of the applied vacuum can extend through the outer surface 108 of an individual transfer puck; through an internal cavity of the transfer puck; through an outlet opening of the transfer puck that is cooperatively joined in an operative fluid communication with the vacuum slot in the corresponding seal ring 78; through the corresponding vacuum slot 82 of the support shaft 116; through the corresponding first vacuum slot 148 in the first adjustment shaft 144; through the corresponding second vacuum slot 158 in the second adjustment shaft 154; and through the vacuum conduit 124 in the support shaft 116.

The first servo motor 34 can be configured to operatively move the first transfer puck 36 along a predetermined rotational path, and the second servo motor 44 can be configured to operatively move, in sequence, the second transfer puck 46 along the predetermined rotational path substantially without contacting the second transfer puck 46 against the first transfer puck 36. Additionally, the third servo motor 54 can be configured to operatively move, in sequence, the third transfer puck 56 along the predetermined rotational path substantially without contacting the third transfer puck 56 against the second transfer puck 46. The third servo motor can also be configured to operatively move the third transfer puck 56 substantially without contacting the third transfer puck 56 against the first transfer puck 46.

Each servo motor (34, 44, 54) can provide a torque of at least a minimum of about 50 Newton-meter (N-m), and alternatively can be at least about 100 N-m. Additionally, the provided torque can be up to about 250 N-m, or more, to provide improved performance. If the motor torque is too low, the servo motor may not be able to provide the desired accelerations and speeds to its corresponding transfer puck. In particular, the transfer puck may not be reliably driven at its desired top-end speed or at its desired deposit speed.

In another feature of the invention, any or each servo motor and its corresponding electronic drive can be configured to cooperatively provide an angular acceleration of at least about 600 radian/sec² to their corresponding transfer puck. If the acceleration is too low, the servo motor and electronic drive may not be able to provide the desired accelerations and speeds to their corresponding transfer puck. In particular, the transfer puck may not be reliably driven at its desired deposit speed, V2, or other desired top-end speed.

Conventional, servo driven systems have ordinarily employed motors with insufficient torque. It has been found that improved operation and improved process control can be obtained by employing a motor with sufficiently high torque. Suitable servo motors can be obtained from Mannesmann Rexroth, Rexroth Indramat Division, a business having offices located in Hoffman Estates, Ill., U.S.A. For example, a suitable servo motor can be provided by a INDRAMAT DIAX4 servo motor.

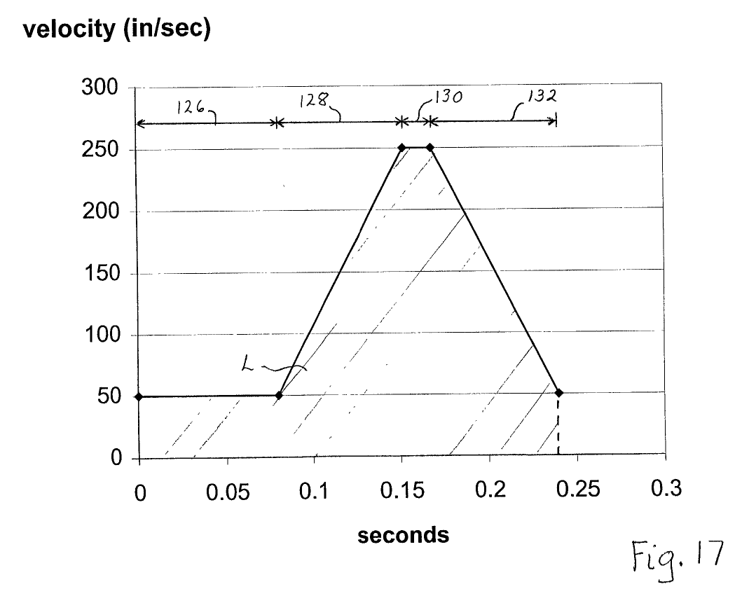

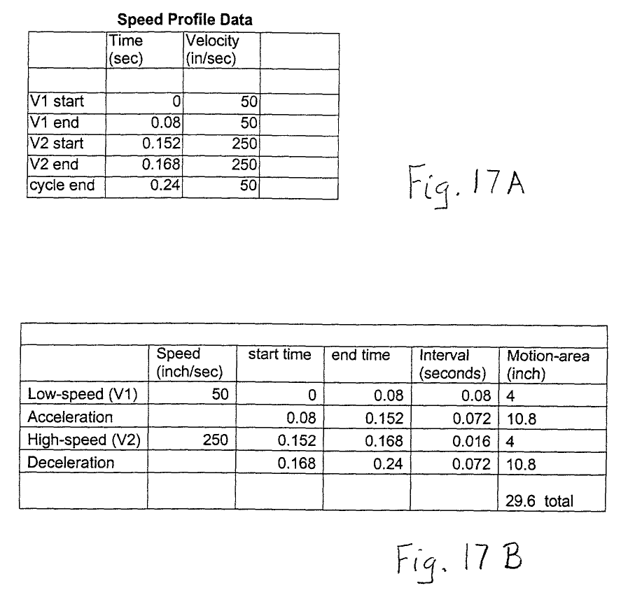

The present invention, can provide a more efficient and more adaptable method and apparatus for receiving discrete components 22 which are traveling at the first pick up speed, and then applying the discrete components 22 to the substrate web 24 which is traveling at the different deposit speed. The required movements of the transfer pucks can be analytically determined, and such movements can, for example, include variable angular velocities with fixed speed dwells. For example, a representative speed profile is illustrated in FIG. 17. As illustrated, each transfer puck can be configured to move through a low-speed dwell interval 126, an acceleration interval 128, an high-speed dwell interval 130, and a deceleration interval 132 during each revolution of the transfer puck around the drive axis 106.

In a particular aspect, the speed of each transfer puck can be independently varied and controlled. When compared to conventional techniques, the present invention can provide greater changes in speed and can better maintain constant speeds for preselected, fixed intervals. The present invention can be more accurately and more efficiently operated to precisely control the length and placement of the discrete components 22 on the moving substrate 24.

The periods of acceleration 128 and deceleration 132 of each transfer puck can be provided by operatively programming the electronic servo drives with the desired motion profiles. The periods of low speed dwell 126 and high speed dwell 130 can also be provided by the programming the electronic servo drives with the desired motion profiles. As such, the combination of the programmed motion profiles and dwell intervals can provide both the desired changes in speed and the desired periods of substantially constant speed to effectively receive and apply the discrete components 22 onto the substrate web 24 at desired, spaced apart locations.

In a particular aspect, the servo drives can be configured and synchronized to provide a desired, operational pattern. In a particular pattern, a first transfer puck can be in the process of delivering a first discrete component 22 to the moving substrate 24; a second transfer puck can be in the process of receiving a second, individual discrete component from a selected component web 92; and a third transfer puck can be in the process of establishing a “ready” position, at which the third transfer puck can begin to receive a third discrete component from the selected component web. In a desired configuration, the third transfer puck can be operatively decelerated from the higher, deposit speed V2 to the lower, pick-up speed V1, and can be positioned closely adjacent to the second transfer puck. When the third transfer puck is arriving at its “ready” position, the second transfer puck can be completing its receipt of the second discrete component, and the cutter can be in the process of separating the second discrete component from the supply of component web material. Accordingly, the third transfer puck can begin receiving the appointed third discrete component immediately after the separating operation has been completed. As the third transfer puck is receiving the third discrete component, the second transfer puck can be accelerated from the lower, pick-up speed V1 to the higher, deposit speed V2. After the first transfer puck has completed its delivery of the first discrete component to the moving substrate 24, the first transfer puck can be operatively decelerated from the higher, deposit speed V2 to the lower, pick-up speed V1, and can be positioned closely adjacent to the second transfer puck to thereby provide a repeat and continuation of the operational pattern.

The present invention can advantageously provide a more accurate and precise control between the movements of the transfer pucks, particularly the two transfer pucks that sequentially become simultaneously and cooperatively located at the “receiving” and “ready” positions. The regulation of each electronically controlled servo can be sufficiently exact to substantially avoid any damaging hitting or clashing of the transfer pucks during this operational period.

In the various configurations of the invention, the radial length to the transfer puck surface 108 and the machine-directional length of the transfer puck can be analytically designed such that each transfer puck receives the discrete components 22 while maintaining a speed at the outer surface of the transfer puck that is substantially equal to the speed of the arriving discrete components 22. In a particular aspect, the surface speed of each transfer puck can also be substantially equal to the speed of the component web 92. Additionally, the surface speed of each transfer puck can be maintained substantially equal to the speed of the moving substrate 24 as the discrete components 22 are applied to the substrate.

The surface speed of each transfer puck can be maintained substantially constant for selected quanta or intervals of dwell. Such dwell intervals can be expressed in any convenient units, such as units of time, length, rotational angle or the like, as well as combinations thereof. In a particular aspect, the surface speed of each transfer puck can be maintained substantially constant as the components are received or applied during corresponding dwell periods or intervals that are expressed in terms of angular amounts of rotation.

In a particular feature, the first servo motor 34 and the first electronic drive 38 can be configured to periodically move the first transfer puck 36 at the pick up speed at a selected pick up location that is provided in an appointed receiving zone of the method and apparatus. Additionally the first servo motor 34 and the first electronic drive 38 can be configured to periodically move the first transfer puck 36 at the deposit speed at a selected deposit location that is provided in an appointed application zone of the method and apparatus. In a similar manner, the second servo motor 44 and the second electronic drive 48 can also be configured to periodically move the second transfer puck 46 at the pick up speed at the selected pick up location, and can be configured to periodically move the second transfer puck 46 at the deposit speed at the selected deposit location. Similarly, the third servo motor 54 and the third electronic drive 58 can be configured to periodically move the third transfer puck 56 at the pick up speed at the selected pick up location, and can be configured to periodically move the third transfer puck 56 at the deposit speed at the selected deposit location.

Each servo motor (34, 44, 54) and its corresponding electronic drive (38, 48, 58, respectively) can be configured to move their respectively connected transfer puck (36, 46, 56) at a selected sequence or other pattern of operating speeds. With reference to FIGS. 17, 17A and 17B, for example, a selected speed or motion profile can be sequentially imparted to each of the transfer pucks. Additionally, the selected speed or motion profile can be periodically repeated by each of the transfer pucks to provide a continual high-speed series of pick-up and deposit operations for a plurality of the discrete components 22.

In a particular aspect, each servo motor and its corresponding electronic drive can be configured to move their associated transfer puck with a selected pick up speed, which can be at least a minimum of about 0.3 m/sec. In another aspect, the pick up speed can be up to about 5.3 m/sec, or more, to provide improved performance. If the pick up speed is too low, there can be an excessive bunching of the component web 92. If the pick up speed is too high, there can be an excessive slippage of the discrete component 22 on the transfer puck, and an inaccurate placement of the discrete component at desired locations on the moving substrate 24.

Each servo motor and its corresponding electronic drive can be configured to move their associated transfer puck with a selected deposit speed. In a particular aspect, the deposit speed can be at least a minimum of about 6 m/sec to provide desired performance. In another aspect, the pick up speed can be up to about 8 m/sec, or more, to provide improved performance. If the deposit speed is outside the desired values, the application of the discrete components 22 onto the moving substrate 24 can impart an excessive shock load onto the moving substrate. The excessive shock load can tear or otherwise adversely deform the material of the moving substrate.

In a further feature, the second, deposit speed can exceed the first, pick up speed by an amount that is sufficient to provide a deposit/pick-up speed ratio of at least a minimum of about 1.5:1. In a desired feature, the speed ratio can be at least about 4:1. The speed ratio can alternatively be at least about 6:1, and optionally, can be at least about 10:1 to provide improved performance.

Each servo motor (34, 44, 54) and its corresponding electronic drive (38, 48, 58, respectively) can cooperatively provide the first pick up speed for a selected pick up dwell interval. In a particular aspect, the pick up dwell interval can substantially correspond to one product repeat. One product repeat is an interval during which one article length 104 of the substrate 24 is moved through or past a predetermined point in the manufacturing process. The interval of a product repeat may be expressed in any convenient units, such as the units of length or time. In a particular configuration, the interval of a product repeat may be expressed in terms of a number of encoder counts, such as a number of encoder counts provided by a line-shaft reference encoder 68 (e.g. FIG. 9).

Each servo motor (34, 44, 54) and its corresponding electronic drive (38, 48, 58, respectively) can cooperatively provide the second deposit speed to their corresponding transfer puck (36, 46, 56, respectively) for a selected, deposit dwell interval. During the deposit dwell interval, an individual discrete component 22 can be applied to an appointed, target location along the moving substrate 24.

For example, the deposit dwell interval, expressed in units of time, can be determined by employing the following formula:

(Lc/Lp)*(M/n)

where:

Lc=machine-directional length of the discrete component 22;

Lp=machine-directional, article length 104 along the substrate 24;

M=amount of time that corresponds to one complete, rotational orbit of a transfer puck around the drive axis 106.

n=number of cooperating transfer pucks employed by the transfer device of the invention.

Any desired combination of dwell intervals and acceleration/deceleration intervals may be employed with the present invention. When the motion or speed profile is plotted with a curve or other diagram of speed as a function of time (e.g. FIG. 17), there is a motion-area under the diagram plot which can be determined for each cycle of the motion. As representatively shown, each single-cycle motion-area (L) can be a total, combined area that is provided under a low-speed interval, a corresponding acceleration interval, a corresponding high-speed interval and a corresponding deceleration interval. The motion-area has the units of length, and in a desired aspect, the length-value of the motion-area can be substantially equal to an orbital path length traversed by a transfer puck during a single orbit of the transfer puck around the rotational drive axis 106. Where the outer surface 108 of the transfer puck is located at a distance of R units from the rotational drive axis 106, the circumferential path length (C) can be determined by the formula:

C=2*π*R.

Accordingly, a desired feature of the method and apparatus can include a configuration wherein: (2*π*R)=C=L.

Once a desired motion profile and associated motion-area (L) are determined, the radius (R) for each transfer puck segment may be calculated by employing the following formula: R=L/(2*π)

In the example representatively presented in FIGS. 17A and 17B, the acceleration and deceleration are constant and linear, and the slopes of the acceleration and deceleration lines are substantially equal (although opposite in direction). Optionally, the acceleration and deceleration can be non-constant and non-linear, and the slope values of the acceleration and deceleration curves can be unequal or otherwise different.

In a particular aspect, an adjusting of the acceleration/deceleration profiles can be employed to electronically grade-change the method and apparatus to accommodate different article lengths 104. The electronic adjustment can provide a range within which the method and apparatus can be grade-changed without also changing the transfer puck radius R. The extent of this electronic adjustment range will, however, depend on the amount of available motor torque.

In another aspect, an adjusting of the balance or ratio of the motion-area under the acceleration curve versus the motion-area under the deceleration curve can be employed to change a position-angle between the in-feed point at which a discrete component is received onto a transfer puck and the application point at which the discrete component is placed onto the target substrate 24. The transfer puck sweeps through the position-angle as the puck travels from the in-feed point to the application point. As representatively shown in FIG. 2, the rotational, angular travel followed by the transfer puck along its circumferential motion path between the in-feed point adjacent the cutter 70 and the application point adjacent the roller 30 can span or sweep through a position-angle of approximately 180°. Accordingly, there can be a substantial equality or balance between (a) the motion-area under the acceleration curve and (b) the motion-area under the deceleration curve. The position-angle can be changed if the method or apparatus is configured to provide acceleration and deceleration areas that are unequal or unbalanced. For example, a position-angle of 120 degrees could be provided by changing the area balance between the acceleration portion of the speed diagram and the deceleration portion of the speed diagram. In particular, the method and apparatus could be configured to provide an acceleration motion-area that is less than the deceleration motion-area to thereby decrease the position-angle between the in-feed point and the application point along the circumferential path of the transfer puck. Alternatively, the method and apparatus could be configured to provide an acceleration motion-area that is greater than the deceleration motion-area to thereby increase the position-angle between the in-feed point and the application point along the circumferential path of the transfer puck.

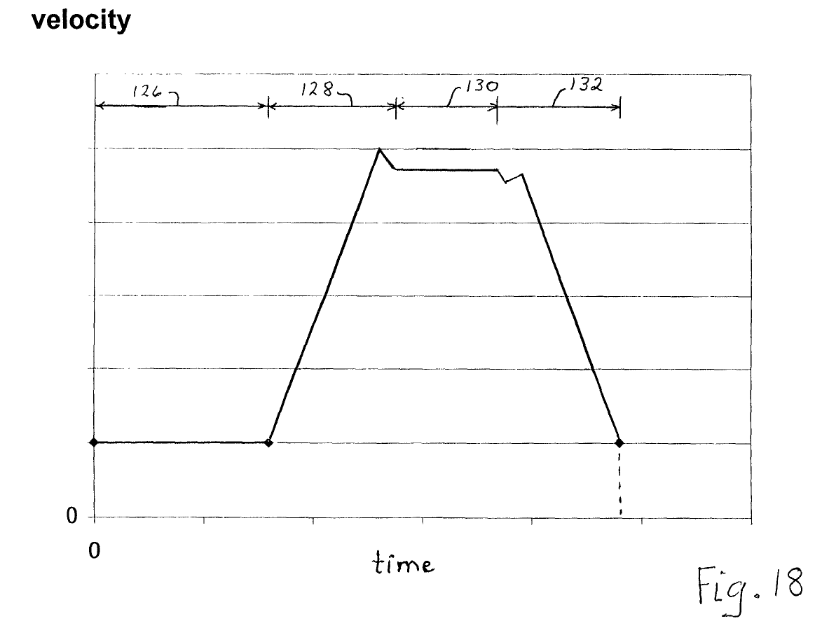

As representatively shown in FIG. 18, the acceleration and/or deceleration curves can be selectively adjusted to include an irregular acceleration curve, and an irregular deceleration curve. In the illustrated example, the acceleration and deceleration curves can incorporate selectively configured spiked areas and/or “dipped” areas. The spiked or dipped areas (or other modifications to the speed plot) can help adjust the motion-area under the diagram plot and help provide the desired relation between the single-cycle motion-area (L) and the circumferential path length (C). In particular, the acceleration and/or deceleration curves can be selectively adjusted to provide a single-cycle motion-area (L) which substantially equals the circumferential path length (C).

The selected modifications to the motion-area under the acceleration and/or deceleration sections of the speed plot can allow a given system with an established puck radius (R) to be electronically grade-changed to accommodate different article lengths or different lengths of the selected discrete components. The grade-change can be made without changing the mechanical set-up of the equipment. In a particular procedure, the speed values and/or durations in the low-speed and/or high-speed dwell interval can be adjusted to accommodate the desired, revised process configuration. Then, one or more other sections of the speed profile can be selectively adjusted to provide a motion-area under the revised speed profile which is substantially the same as the motion-area that was previously provided under the speed profile employed before the grade-change. An operative modification may add motion-area under a selected section of the previous speed profile, or may subtract motion-area from a selected section of the previous speed profile. It should be appreciated that the modifications to the speed plot can be selected and arranged to substantially avoid clashing between adjacent transfer pucks.

It should be appreciated that the torque (T) applied by each servo motor can be related to the acceleration of its correspondingly connected transfer puck in accordance with the formula:

T=I*α

where:

I=total rotational mass moment of inertia of a transfer puck and all of the rotational components employed to connect the transfer puck to its corresponding servo motor and operably rotate that transfer puck;

α=angular acceleration of the transfer puck (e.g. radians/sec²).

The torque provided by the servo motor should large enough to overcome the rotational inertia of its corresponding transfer puck system and provide the desired levels of acceleration and deceleration to its corresponding transfer puck.

With reference to FIG. 1, the selected discrete component 22 can have a length 100 along its machine-direction, and can have a length 102 along its cross-direction. Where the component 22 has a machine-direction length of about 4.45 inches (about 11.3 cm) and a cross-direction length 102 of about 18.7 inches (about 47.5 cm), each servo motor and its corresponding electronic drive can be configured to provide an angular acceleration (or deceleration) of at least about 600 radian/sec² to their associated transfer puck.

In another feature, the invention can further include a synchronizer system which can maintain a selected sequence of relative positions and separation distances between the first transfer puck 36 and the second transfer puck 46 during their movements along the predetermined rotational path. The synchronizer system can also operatively maintain a selected sequence of relative positions and separation distances between the third transfer puck 56 and the second transfer puck 46 during their movements along the predetermined rotational path, and similarly, can operatively maintain a selected sequence of relative positions and separation distances between the third transfer puck 56 and the first transfer puck 36.

The method and apparatus of the invention can operatively control and maintain a desired registration between target positions along the moving substrate 24, and placement locations of the discrete components 22 onto the substrate 24. In a particular aspect, each servo motor and its corresponding electronic drive can have the ability to position-lock, and keep in phase with the line-shaft reference encoder 68 (e.g. FIG. 9).

The line-shaft encoder 68 can be connected to a main, line shaft of the manufacturing equipment, and the line shaft can be connected to a conventional drive mechanism (not shown) that is operatively configured to move the conveyor that is employed to transport the web 24 through the process and apparatus. Desirably, the connection can be through an adjustable ratio gear box, or other operative device, which can be selectively controlled such that one revolution of the line-shaft encoder can substantially correspond to one article-length 104 of the moving web 24. Other operative arrangements, with different relationships between article-length and the rotation of the line-shaft encoder, may also be employed.

The line-shaft encoder 68 can provide a metering mechanism for generating substantially regularly occurring phasing pulses. The shown configuration of the invention can, for example, generate approximately 8×10⁶ phasing pulses per shaft revolution, and can generate approximately 4×10⁶ encoder pulses per article length. These pulses can be employed as a “ruler” to measure the phase and position relationships between the various electrical signals generated by the apparatus of the invention, and can be employed to develop desired measurements of the distances between selected components of a product web. In the shown configuration of the invention, the phasing pulses can be in the form of electrical signals, which are suitably directed to an operative computer processing unit 110 through appropriate electrical conductors (e.g. FIG. 9). The use and operation of line-shaft encoders and associated computer processing units are well known in the art.

In a desired configuration, the line-shaft encoder 68 can include an electronically readable system for producing encoder pulses. In a particular arrangement, the line-shaft encoder can include an optically-readable disk that is connected to an axis of rotation of the main, line-shaft of the manufacturing operation that employs the technique of the present invention. Other types of readable media, such as magnetic materials or the like, may be employed. In a representative configuration, the line-shaft encoder disk can be an etched disk, and a light source and cooperating photo-detector devices can be employed to read the line-shaft encoder disk. Optionally, other reading devices may be employed, as desired. An example of a suitable line-shaft encoder is a model No. H25, which can be obtained from BEI Technologies, Inc., a business having offices located in Goleta, Calif., U.S.A.

The line-shaft reference encoder can be configured to provide an absolute encoder. Additionally, each servo-drive system can be configured to provide an absolute encoder. The absolute encoder is configured to provide a marker pulse which can provide a marker reference for each rotation of the encoder. For example, the absolute encoder can have an encoder disk which is configured to provide the desired marker pulse. As a result, a set reference, starting point can be accurately found and maintained by keeping track of a number of encoder pulses that are counted from the provided marker pulse.

Each electronic servo drive 38, 48 and 58 can be synchronized so that each corresponding transfer puck 36, 46 and 56, respectively, stays in phase, and do not clash with each other. The synchronizing can be done by employing a selected encoder set up for each servo drive. A master cam profile is established by employing the speed profile or other motion profile desired for each transfer puck. A representative motion profile is shown in FIG. 17. Each servo drive 38, 48 and 58 can have a corresponding servo encoder 62, 64 and 66 respectively, as representatively shown in FIG. 9. Each servo encoder can be referenced to the master cam profile, and each servo encoder can be offset from the other encoders by a selected interval. The master cam profile can desirably be phased and position-locked with respect to the line-shaft reference encoder 68. The phasing and position-locking can be accomplished by setting the line-shaft encoder reference to “zero” with respect to a mechanical stop employed for each transfer puck, and programming the electronic drive to provide an operative offset between the transfer pucks. For example, the offset may be expressed in terms of degrees of puck rotation around the drive axis 106. Accordingly, the offset may be determined by the formula, 360°/n, where “n” is the number of transfer pucks employed by the desired transfer device. For example, where the method an apparatus employs three servo drives, the associated, three encoders can be offset from one another by approximately 120 degrees of rotation.

The servo drives can be synchronized so that each corresponding transfer puck maintains a desired timing with respect to the selected cutter 70. This can be accomplished by employing a cutter encoder 98 which is operatively connected to a cutter servo 72 and a corresponding cutter servo drive 73. The cutter encoder 98 can be phase and position locked to the line-shaft reference encoder 68 by employing the computer and associated software 110. The phasing and position-locking of the cutter encoder 98 can be accomplished by setting the cutter knife to the appointed cutting anvil on a transfer puck, and “zeroing” the cutter encoder.

Each servo drive can employ a distinctive, high-resolution encoder to provide improved accuracy and improved process control. In a particular feature, the servo drive encoder (62, 64, 66) can provide at least a minimum of about one million pulses per revolution. In a desired feature, each servo drive encoder (62, 64, 66) can provide at least about two million pulses per revolution. In a further feature, the servo drive encoder (62, 64, 66) can provide at least about four million pulses per revolution.

If the number of encoder pulses per revolution is too low, the transfer device can have insufficient resolution and insufficient accuracy. As a result, the transfer pucks can be inadequately controlled, and the relative motions of one transfer puck, as compared to the motions of an adjacent transfer puck, can excessively drift. The excessive drift can cause the adjacent transfer pucks to clash or collide with each other, and the resulting contact can disrupt the transfer operation or damage the equipment.

In particular feature, each servo drive encoder can include an optically-readable disk. For example, a representative configuration can include an operative light source and an operative system of one or more photo-detectors which are constructed and arranged to read an etched, encoder disk. Optionally, other reading devices or systems may be employed, as desired. A suitable encoder system for the servo drive can be obtained from the vendor of the chosen, electronic servo drive. For example, a suitable servo drive encoder can be a component of a INDRAMAT DIAX04 servo system which is available from Mannesmann Rexroth, Rexroth Indramat Division, a business having offices located in Hoffman Estates, Ill., U.S.A. It should be readily appreciated that other readable media and cooperating reading devices may be employed to provide a suitable encoder.

Each servo drive unit 38, 48 and 58 can be programmed or otherwise configured to provide a selected product-to-component ratio. The product-to-component ratio can be determined by taking the machine-direction length 100 of the selected component 22 divided by a predetermined, machine-directional length 104 of an appointed article segment along the moving substrate 24 (e.g. FIGS. 1 and 2). The product-to-component ratio can be as low as 1:1 and can be up to about 6:1, or more. The product-to-component ratio can be as high as 8:1, and optionally, can be as high as 10:1 to provide improved efficiencies and performance flexibilities.

The programming for controlling the desired moving, positioning and synchronizing and other operations incorporated by the present invention can be accomplished by employing any suitable, computer hardware and software 110 (e.g. FIG. 9). In the representatively shown configuration, for example, the computer and programming system can be provide by an INDRAMAT servo motion drive system and associated INDRAMAT, VISUAL MOTION software. This hardware and software can be obtained from Mannesmann Rexroth, Rexroth Indramat Division, a business having offices located in Hoffman Estates, Ill., U.S.A.

In a desired aspect, each or any of the electronic servo drives 38, 48 and 58 can be programmed with a desired velocity profile. The desired velocity profile can be determined by employing the desired pick up speed, V1, and the desired deposit speed, V2, and by employing the time left in a corresponding cycle timing diagram for accomplishing the desired non-jerk accelerations between the pick up and deposit of the discrete components 22.

The pick up speed V1 can be determined by dividing the machine-directional length 100 of a discrete component 22 by the interval of time (T1) over which a complete, component length is moved past a predetermined point of the transfer system 20 during the intended processing operation. For example, the component interval T1 can be the interval of time over which a complete, component length is delivered to a transfer puck. The deposit speed V2 can be determined by dividing the length 104 of an appointed article segment of the substrate 24 by the interval of time (T2) over which the one article length 104 of the substrate 24 is moved past the predetermined point (e.g. the drive axis 106) of the transfer system 20 during the intended processing operation. For example, the article-length interval T2 can be the interval of time over which the one article length 104 of the substrate 24 is moved past the drive axis 106 of the transfer system In a desired configuration, the component time interval T1 can substantially equal the article-length time interval T2. Accordingly, the interval of time over which the length of one discrete component 22 is moved onto a transfer puck can be substantially equal to the interval of time over which one article length 104 of the substrate 24 is moved past the drive axis 106 of the transfer system 20. Such an arrangement can better accommodate the transfer and placement of curved components, and can better accommodate an intermittent, spaced-apart placement of irregular-shaped or odd-shaped components. As a result, the particular configuration of the invention can provide a more precise control of the length and placement of the selected discrete component 22 onto the moving web 24

A motion profile can, for example, be defined by a graphical representation of the changes in speed (e.g. inch/sec—y axis) over time (e.g. seconds—x axis), as representatively shown in FIG. 17. Selected values can be derived from the motion profile, and these values can be entered into an INDRAMAT, CAM BUILDER TABLE software package. For example, values for the parameters set forth in the data table of FIG. 17A can be entered. Once the desired cam profile has been sufficiently defined with the values called for by the CAM BUILDER TABLE software, a “Build” command is entered to effect a smoothing function that operatively removes any discontinuities or abrupt changes from the inputted motion data. The resulting programming file can provide a master cam profile, and can be downloaded into the drive memory of each INDRAMAT servo system. When put into operation, a feedback signal from the servo encoder is compared, over time, to the cam-table values that were downloaded into the drive memory. A variance from the desired motion profile generates an error signal, which is employed to call for more or less current, as is appropriate to make a correction that keeps the servo motor encoder synchronized with the desired motion profile lines.

It should be readily apparent to those of ordinary skill in the art that the present invention may be utilized in any circumstance requiring speed variations and constant speed dwells when transferring components in a desired operation, such as an operation that applies individual, discrete components onto a moving web. It should also be readily apparent that the various components employed in the present invention can be constructed from any suitable material. The materials may be natural or synthetic, and may include wood, metal, plastics, synthetic polymers, resins or the like, as well as combinations thereof. The selected materials should have sufficient levels of strength, rigidity, durability, and low-weight, as required by the chosen configuration of the invention.

While various illustrative and representative configurations have been described in detail herein, it is to be appreciated that other arrangements, variants, modifications and equivalents thereto would be readily apparent to persons of ordinary skill. All of such arrangements, variations, modifications and equivalents are contemplated as being within the scope of the present invention, as set forth by the subjoined claims.

1. An apparatus for applying discrete components onto a moving substrate, said apparatus including:
a first rotatable drive member;
at least a second rotatable drive member which is substantially coaxial with said first drive member;
a first servo motor connected to rotate said first drive member;
at least a second servo motor connected to rotate said second drive member;
a first transfer puck driven by said first rotatable drive member;
at least a second transfer puck driven by said second rotatable drive member;
a first electronic drive connected to said first servo motor, said first electronic drive configured to selectively move said first transfer puck at a first, pickup speed and at least a second, deposit speed;
at least a second electronic drive connected to said second servo motor, said second electronic drive configured to selectively move said second transfer puck at said first pickup speed and at said second deposit speed.

2. An apparatus as recited in claim 1, further including a transport mechanism for moving said substrate at said deposit speed.

3. An apparatus as recited in claim 1, wherein said first transfer puck is configured to carry a first discrete component for placement onto said moving substrate; and said second transfer puck is configured to carry at least a second discrete component for placement onto said moving substrate.

4. An apparatus as recited in claim 1, wherein said first rotatable drive member and at least said second rotatable drive member are substantially concentric.

5. An apparatus as recited in claim 1, wherein said first transfer puck is operatively connected to said first rotatable drive member with a first, radially extending arm member; and said second transfer puck is operatively connected to said second rotatable drive member with a second, radially extending arm member.

6. An apparatus as recited in claim 1, wherein
said first servo motor is configured to operatively move said first transfer puck along a predetermined rotational path; and
said second servo motor is configured to operatively move, in sequence, said second transfer puck along said predetermined rotational path substantially without contacting said second transfer puck against said first transfer puck.

7. An apparatus as recited in claim 1, further including a synchronizer which can maintain a selected sequence of relative separation distances between said first transfer puck and said second transfer puck during their movements along said predetermined rotational path.

8. An apparatus as recited in claim 1, wherein said first servo motor and said first electronic drive are configured to move said first transfer puck to provide a deposit speed of at least about 6 m/sec.

9. An apparatus as recited in claim 1, wherein said first servo motor can provide a torque of at least about 50 Newton-meter.

10. An apparatus as recited in claim 1, wherein said second servo motor can provide a torque of at least about 50 Newton-meter.

11. An apparatus as recited in claim 1, wherein said first servo motor and said first electronic drive can cooperatively provide said first, pickup speed for a pickup dwell interval which substantially corresponds to one product repeat.

12. An apparatus as recited in claim 1, wherein said second servo motor and said second electronic drive can cooperatively provide said first, pickup speed for a pickup dwell interval which substantially corresponds to one product repeat.

13. An apparatus as recited in claim 1, wherein said second, deposit speed differs from said first, pickup speed to provide a deposit/pick-up speed ratio of at least about 1.5:1.

14. An apparatus as recited in claim 1, wherein said first servo motor and said first electronic drive can cooperatively provide an angular acceleration of at least about 600 radian/sec² to said first transfer puck.

15. An apparatus as recited in claim 1, further including a retaining mechanism configured to releasably hold a discrete component on said first transfer puck.

16. An apparatus as recited in claim 15, wherein said retaining mechanism includes a vacuum device.

17. An apparatus as recited in claim 1, further including:
a third rotatable drive member which is substantially coaxial with said first drive member;
a third servo motor connected to rotate said third drive member;
a third transfer puck driven by said first rotatable drive member; and
a third electronic drive connected to said third servo motor, said third electronic drive configured to selectively move said third transfer puck at said first pickup speed and at said second deposit speed.

18. An apparatus for changing a speed of discrete components, said apparatus including:
a first rotatable drive member;
at least a second rotatable drive member which is substantially coaxial with said first drive member;
a first servo motor connected to rotate said first drive member;
at least a second servo motor connected to rotate said second drive member;
a first transfer puck driven by said first rotatable drive member;
at least a second transfer puck driven by said second rotatable drive member;
a first electronic drive connected to said first servo motor, said first electronic drive configured to selectively move said first transfer puck at a first, pickup speed and at least a second, deposit speed;
at least a second electronic drive connected to said second servo motor, said second electronic drive configured to selectively move said second transfer puck at said first pickup speed and at said second deposit speed.

19. A method for applying discrete components onto a moving substrate, said method including:
a providing of a first rotatable drive member;
a providing at least a second rotatable drive member which is substantially coaxial with said first drive member;
a connecting of a first servo motor to rotate said first drive member;
a connecting of at least a second servo motor to rotate said second drive member;
a driving of a first transfer puck with said first rotatable drive member;
a driving of at least a second transfer puck with said second rotatable drive member;
a connecting of a first electronic drive to said first servo motor, said first electronic drive configured to selectively move said first transfer puck at a first pickup speed and at least a second deposit speed;
a connecting of at least a second electronic drive to said second servo motor, said second electronic drive configured to selectively move said second transfer puck at said first pickup speed and at said second deposit speed.

20. A method for applying discrete components onto a moving substrate, said method including:
a rotating of a first rotatable drive member with a first servo motor;
a providing of at least a second rotatable drive member which is substantially coaxial with said first drive member;
a rotating of said second rotatable drive member with a second servo motor;
a moving of a first transfer puck with said first rotatable drive member, said first transfer puck configured to place a first discrete component onto said moving substrate;
a moving of at least a second transfer puck with said second rotatable drive member, said second transfer puck configured to place a second discrete component onto said moving substrate;
a connecting of a first electronic drive to said first servo motor, said first electronic drive configured to selectively move said first transfer puck at a first pickup speed and at least a second deposit speed;
a connecting of at least a second electronic drive to said second servo motor, said second electronic drive configured to selectively move said second transfer puck at said first pickup speed and at said second deposit speed.

21. A method for changing a speed of discrete components, said method including:
a rotating of a first rotatable drive member with a first servo motor;
a providing of at least a second rotatable drive member which is substantially coaxial with said first drive member;
a rotating of said second rotatable drive member with a second servo motor;
a moving of a first transfer puck with said first rotatable drive member, said first transfer puck configured to place a first discrete component onto said moving substrate;
a moving of at least a second transfer puck with said second rotatable drive member, said second transfer puck configured to place a second discrete component onto said moving substrate;
a connecting of a first electronic drive to said first servo motor, said first electronic drive configured to selectively move said first transfer puck at a first pickup speed and at least a second deposit speed;
a connecting of at least a second electronic drive to said second servo motor, said second electronic drive configured to selectively move said second transfer puck at said first pickup speed and at said second deposit speed.

22. A method as recited in claim 19, further including a configuring of said first servo motor to provide a torque of at least about 100 Newton-meter.

23. A method as recited in claim 19, further including a configuring of said first servo motor and said first electronic drive to provide a deposit/pick-up speed ratio which is at least about 1.5:1.

24. A method as recited in claim 19, further including a configuring of said first servo motor and said first electronic drive to cooperatively provide an angular acceleration of at least about 600 radian/sec² to said first transfer puck.

25. A method as recited in claim 19, further including
an operatively moving of said first transfer puck along a predetermined rotational path; and
an operatively moving of said second transfer puck, in sequence, along said predetermined rotational path substantially without contacting said second transfer puck against said first transfer puck.

26. A method as recited in claim 19, further including
a providing of a third rotatable drive member which is substantially coaxial with said first drive member;
a connecting of a third servo motor to rotate said third drive member;
a driving of a third transfer puck with said third rotatable drive member;
a connecting of a third electronic drive to said third servo motor, said third electronic drive configured to selectively move said third transfer puck at said first pickup speed and at least said second deposit speed.

27. A method as recited in claim 26, further including
an operatively moving of said first transfer puck along a predetermined rotational path;
an operatively moving of said second transfer puck, in sequence, along said predetermined rotational path substantially without contacting said second transfer puck against said first transfer puck; and
an operatively moving of said third transfer puck, in sequence, along said predetermined rotational path substantially without contacting said third transfer puck against said first or second transfer pucks.

28. A method as recited in claim 21, further including
a configuring of said moving of said first transfer puck to provide an orbital path length of said first transfer puck; and
a configuring of said moving of said first transfer puck to correspond to a speed profile which provides a single-cycle motion-area value that substantially equals said orbital path length of said first transfer puck.
